(19) United States
(12) Patent Application Publication
(10) Pub. No.: US 2016/0378311 A1
(43) Pub. Date: Dec. 29, 2016

(54) METHOD FOR OUTPUTTING STATE CHANGE EFFECT BASED ON ATTRIBUTE OF OBJECT AND ELECTRONIC DEVICE THEREOF

(71) Applicant: Samsung Electronics Co., Ltd., Suwon-si (KR)

(72) Inventors: Han-Jib KIM, Suwon-si (KR); Sungkyu CHOI, Seoul (KR); Jeongheon KIM, Seoul (KR); Yongjoon JEON, Hwaseong-si (KR)

(21) Appl. No.: 15/182,895

(22) Filed: Jun. 15, 2016

(30) Foreign Application Priority Data
Jun. 23, 2015 (KR) 10-2015-0089106

(51) Int. Cl. G06F 3/0484; G06F 3/0482; G06F 3/0488

(52) U.S. Cl. CPC G06F 3/04845; G06F 3/04883; G06F 3/0482

(57) ABSTRACT

A device for outputting a state change effect based on an attribute of an object in an electronic device and a method thereof are provided. The electronic device includes a touch screen display, a processor electrically connected to the touch screen display, and a memory electrically connected to the processor. The memory may store instructions enabling the processor to display a lock screen including a first object and a second object on the touch screen display, to receive a touch or a gesture input related to the first object or the second object through the touch screen display, to display a first visual effect on the screen when the processor receives an input related to the first object, and to display a second visual effect on the screen when the processor receives an input related to the second object, when the instructions are executed.

### CROSS-REFERENCE TO RELATED APPLICATION(S)

This application claims the benefit under 35 U.S.C. §119(a) of a Korean patent application filed on Jun. 23, 2015 in the Korean Intellectual Property Office and assigned Serial number 10-2015-0089106, the entire disclosure of which is hereby incorporated by reference.

### TECHNICAL FIELD

The present disclosure relates to a device for outputting a state change effect based on an attribute of an object in an electronic device, and a method thereof.

### BACKGROUND

With the development of information and communication technologies and semiconductor technologies, various types of electronic devices have developed into multimedia devices that provide various multimedia services. For example, portable electronic devices may provide diverse multimedia services, such as broadcast services, wireless Internet services, camera services, and music playback services.

An electronic device provides various user interfaces to a user as the user's use of the electronic device increases. For example, the electronic device may provide a lock screen that is capable of inputting a theme or a pattern configured by a user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device that may provide a standardized user interface configured by a user. The electronic device needs a user interface for satisfying various requirements of a user.

Another aspect of the present disclosure is to provide a device for outputting a state change effect based on an attribute of at least one object in an electronic device and a method thereof.

In accordance with an aspect of the present disclosure, an electronic device is provided. The electronic device includes a touch screen display, a processor electrically connected to the touch screen display, and a memory electrically connected to the processor. The memory is configured to store instructions that when executed configure the processor to display a background image including a first object and a second object as a lock screen on the touch screen display, extract the first object and the second object in the background image, receive a touch or a gesture related to the first object or the second object through the touch screen display, display a first visual effect on the screen when the processor receives an input related to the first object, and display a second visual effect on the screen when the processor receives an input related to the second object.

In accordance with another aspect of the present disclosure, an electronic device is provided. The electronic device includes a touch screen display, a processor electrically connected to the touch screen display, and a memory electrically connected to the processor. The memory configured to store instructions that when executed configured the processor to provide a state in which the processor receives a touch input through only a selected area of the screen, while displaying a screen including a first object of a first size, on a substantial whole of the touch screen display, display a first amount of first contents in the first object on the touch screen display, change the first object to a second size different from the first size on the touch screen display, and display a second amount of the first contents or second contents related to the first contents in the first object of the second size on the touch screen display, when the instructions are executed.

In accordance with another aspect of the present disclosure, an electronic device is provided. The electronic device includes a touch screen display, a processor electrically connected to the touch screen display, and a memory electrically connected to the processor. The memory configured to store instructions that when executed configured the processor to provide a state in which the processor receives a touch input through only a selected area of the screen, while displaying a screen including a first object and a second object, using a substantial whole of the touch screen display, display a third object which may trigger a first function and remove the first object, in response to at least some of a first user input selecting the first object, and display a fourth object which may trigger a second function and remove the second object, in response to at least some of a second user input selecting the second object, when the instructions are executed.

In accordance with another aspect of the present disclosure, a method of operating an electronic device is provided. The method includes displaying a background image including a first object and a second object as a lock screen on a display of the electronic device, extracting the first object and the second object in the background image, receiving a touch or a gesture input related to the first object or the second object, displaying a first visual effect on the screen when an input related to the first object is received, and displaying a second visual effect on the screen when an input related to the second object is received.

In accordance with another aspect of the present disclosure, a method of operating an electronic device is provided. The method includes displaying a screen including a first object of a first size, on a substantial whole of a display of the electronic device, displaying a first amount of first contents in the first object on the touch screen display, changing the first object to a second size different from the first size on the touch screen display, and displaying a second amount of the first contents or second contents related to the first contents in the first object of the second size on the touch screen display.

In accordance with another aspect of the present disclosure, a method of operating an electronic device is provided. The method includes displaying a screen including a first object and a second object, using a substantial whole of a display of the electronic device, displaying a third object which may trigger a first function and removing the first object, in response to at least some of a first user input selecting the first object, and displaying a fourth object which may trigger a second function and removing the second object, in response to at least some of a second user input selecting the second object.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device in a network environment in various embodiments according to various embodiments of the present disclosure;

FIG. 2 illustrates a block diagram of an electronic device according to various embodiments of the present disclosure;

FIG. 3 illustrates a block diagram of a program module according to various embodiments of the present disclosure;

FIG. 4 illustrates an electronic device for outputting a state change effect according to various embodiments of the present disclosure;

FIG. 5 illustrates a flowchart for outputting a state change effect corresponding to an object in an electronic device according to various embodiments of the present disclosure;

FIG. 6 illustrates a flowchart for outputting a state change effect based on an attribute of an object in an electronic device according to various embodiments of the present disclosure;

FIGS. 7A to 7C illustrate a screen configuration for outputting a state change effect based on an attribute of an object in an electronic device according to various embodiments of the present disclosure;

FIGS. 8A to 8C illustrate a screen configuration for outputting a state change effect corresponding to an object attribute in an electronic device according to various embodiments of the present disclosure;

FIG. 9 illustrates a flowchart for outputting a state change effect based on an attribute of a screen in an electronic device according to various embodiments of the present disclosure;

FIGS. 10A and 10B illustrate a screen configuration for outputting a state change effect based on an attribute of a screen in an electronic device according to various embodiments of the present disclosure;

FIGS. 11A to 11C illustrate a screen configuration for outputting a state change effect corresponding to a screen attribute in an electronic device according to various embodiments of the present disclosure;

FIG. 12 illustrates a flowchart for outputting a state change effect based on a system attribute in an electronic device according to various embodiments of the present disclosure;

FIG. 13 illustrates a flowchart for performing an operation corresponding to an event generation condition of an object in an electronic device according to various embodiments of the present disclosure;

FIG. 14 illustrates a screen configuration for performing an operation corresponding to an event generation condition of an object in an electronic device according to various embodiments of the present disclosure;

FIG. 15 illustrates a flowchart for outputting a state change effect corresponding to an event generation in an electronic device according to various embodiments of the present disclosure;

FIG. 16 illustrates a flowchart for displaying event generation information based on an object size in an electronic device according to various embodiments of the present disclosure;

FIGS. 17A and 17B illustrate a screen configuration for displaying event generation information based on an object size in an electronic device according to various embodiments of the present disclosure;

FIG. 18 illustrates a flowchart for displaying event generation information based on a renewed size of an object in an electronic device according to various embodiments of the present disclosure;

FIGS. 19A to 19C illustrate a screen configuration for displaying event generation information based on a renewed size of an object in an electronic device according to various embodiments of the present disclosure;

FIG. 20 illustrates a flowchart for outputting a state change effect based on a relation of a plurality of objects in an electronic device according to various embodiments of the present disclosure;

FIGS. 21A and 21B illustrate a screen configuration for outputting a state change effect based on a relation of a plurality of objects in an electronic device according to various embodiments of the present disclosure;

FIGS. 22A to 22C illustrate a screen configuration for outputting a state change effect corresponding to a relation of a plurality of objects in an electronic device according to various embodiments of the present disclosure;

FIG. 23 illustrates a flowchart for performing an operation corresponding to an object in an electronic device according to various embodiments of the present disclosure;

FIGS. 24A and 24C illustrate a screen configuration for performing an operation corresponding to an object in an electronic device according to various embodiments of the present disclosure;

FIGS. 25A and 25B illustrate a screen configuration for performing an operation corresponding to an object based on a selection of the object in an electronic device according to various embodiments of the present disclosure;

FIG. 26 illustrates a flowchart for configuring a security grade such that the security grade corresponds to an event generation condition in an electronic device according to various embodiments of the present disclosure;

FIGS. 27A to 27C illustrate a screen configuration for configuring a security grade such that the security grade corresponds to an event generation condition in an electronic device according to various embodiments of the present disclosure;

FIGS. 28A to 28F illustrate a screen configuration for highlighting a state change effect corresponding to an object attribute in an electronic device according to various embodiments of the present disclosure;

FIG. 29 illustrates a flowchart for configuring a state change effect corresponding to an object attribute in an electronic device according to various embodiments of the present disclosure;

FIG. 30 illustrates a flowchart for generating a state change effect corresponding to an object attribute in an electronic device according to various embodiments of the present disclosure;

FIG. 31 illustrates a flowchart for configuring a state change effect corresponding to an object attribute in a server according to various embodiments of the present disclosure;

FIG. 32 illustrates a flowchart for configuring a state change effect corresponding to an object attribute using a server in an electronic device according to various embodiments of the present disclosure;

FIG. 33 illustrates a flowchart for configuring a state change effect corresponding to an object attribute using a server in an electronic device according to various embodiments of the present disclosure;

FIG. 34 illustrates a flowchart for detecting an attribute of an object included in a wallpaper provided from an electronic device by a server according to various embodiments of the present disclosure;

FIG. 35 illustrates a flowchart for configuring a state change effect of an object included in a wallpaper using a server in an electronic device according to various embodiments of the present disclosure; and

FIG. 36 illustrates a flowchart for configuring a state change effect of an object included in a wallpaper provided from an electronic device by a server according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, operations, elements, parts, or a combination thereof described in the specifications, and do not preclude the presence or addition of one or more other features, numbers, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e g, third element) between the element and another element. To the contrary, it will be understood that when an element (e.g., first element) is “directly connected” or “directly coupled” to another element (e.g., second element), there is no intervening element (e g, third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a central processing unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

An electronic device according to various embodiments of the present disclosure, for example, may include at least one of a smartphone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), a Moving Picture Experts Group phase 1 or phase 2 (MPEG-1 or MPEG-2) audio layer 3 (MP3) player, a mobile medical appliance, a camera, and a wearable device (e.g., smart glasses, a head-mounted-device (HMD), electronic clothes, an electronic bracelet, an electronic necklace, an electronic appcessory, an electronic tattoo, a smart mirror, or a smart watch).

According to some embodiments of the present disclosure, the electronic device may be a smart home appliance. The home appliance may include at least one of, for example, a television (TV), a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

Hereinafter, an attribute of an object may include a visual attribute included in an object image, such as a shape, a color, a size, and a position, and an emotional attribute for the object image. For example, in the case of a human's face image, the emotional attribute may include a happy look, a sad look, a smiling face, a poker face, and the like.

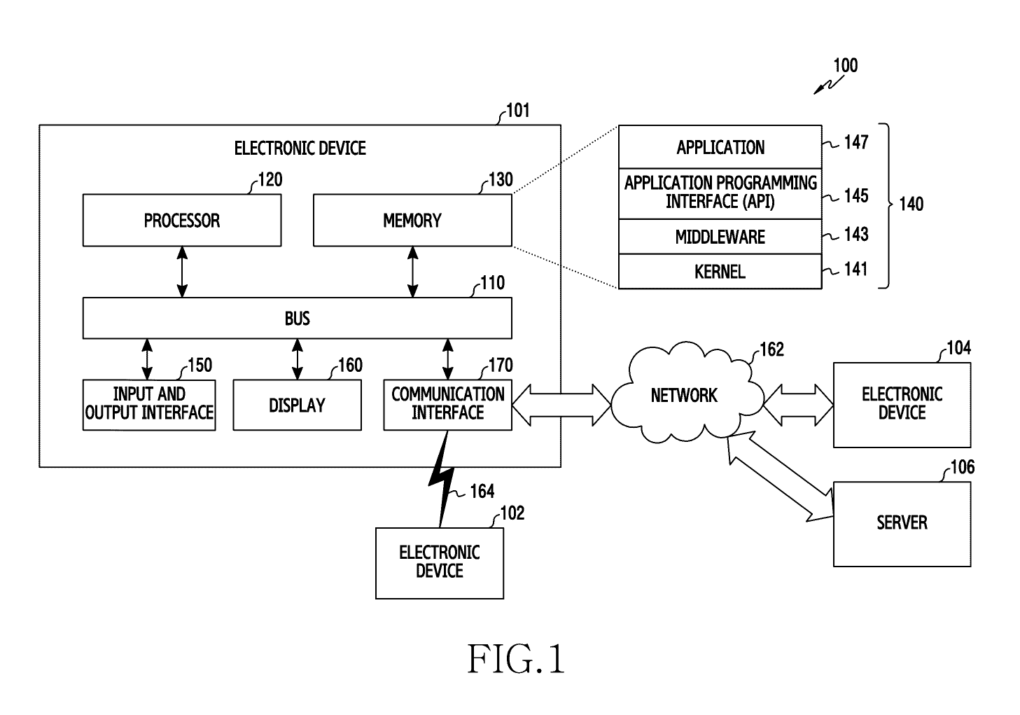

FIG. 1 illustrates an electronic device 101 in a network environment 100 in various embodiments according to various embodiments of the present disclosure. The electronic device 101 may include a bus 110, a processor 120 (e.g., including processing circuitry), a memory 130, an input/output interface 150 (e.g., including input/output circuitry), a display 160 (e.g., including a display panel and display circuitry), and a communication interface 170 (e.g., including communication circuitry). In some embodiments of the present disclosure, the electronic device 101 may omit at least one of the above elements or may further include other elements.

Referring to FIG. 1, the bus 110 may include, for example, a circuit that interconnects the components 120 to 170 and delivers communication (for example, a control message and/or data) between the components 120 to 170.

The processor 120 may include one or more of a CPU, an AP, and a communication processor (CP). For example, the processor 120 may carry out operations or data processing relating to control and/or communication of at least one other element of the electronic device 101.

According to an embodiment of the present disclosure, the processor 120 may control the input/output interface 150 or the display 160 to output a state change effect of an object based on an attribute of at least one object.

The memory 130 may include a volatile memory and/or a non-volatile memory. The memory 130 may store, for example, instructions or data (e.g., a local postponement sound or a network postponement sound) related to at least one other component. According to an embodiment of the present disclosure, the memory 130 may store software and/or a program 140. For example, the program may include a kernel 141, a middleware 143, an application programming interface API 145, an application program (or application) 147, or the like. At least some of the kernel 141, the middleware 143, and the API 145 may be referred to as an operating system (OS).

The input/output interface 150 may function as, for example, an interface that may transfer instructions or data input from a user or another external device to the other element(s) of the electronic device 101. Furthermore, the input/output interface 150 may output the instructions or data received from the other element(s) of the electronic device 101 to the user or another external device.

According to an embodiment of the present disclosure, the input/output interface 150 may include an audio processing unit and a speaker for outputting an audio signal. For example, the audio processing unit may output the audio signal corresponding to the attribute of the object through the speaker.

The display 160 may display, for example, various types of contents (for example, text, images, videos, icons, or symbols) for the user. The display 160 may include a touch screen and receive, for example, a touch, gesture, proximity, or hovering input by using an electronic pen or the user's body part.

The communication interface 170 may set communication between, for example, the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106). For example, the communication interface 170 may communicate with the external device (for example, the first external electronic device 102) through short range communication 164.

The network 162 may include at least one of communication networks, such as a computer network (e.g., a local area network (LAN) or a wide area network (WAN)), the Internet, and a telephone network.

Each of the first and second external electronic devices 102 and 104 may be a device which is identical to or different from the electronic device 101. According to an embodiment of the present disclosure, the server 106 may include a group of one or more servers. According to various embodiments of the present disclosure, all or some of the operations performed in the electronic device 101 may be performed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may make a request for performing at least some functions relating thereto to another device (for example, the electronic device 102 or 104, or the server 106) instead of performing the functions or services by itself or in addition. Another electronic device (for example, the electronic device 102 or 104, or the server 106) may execute the requested functions or the additional functions, and may deliver a result of the execution to the electronic device 101. The electronic device 101 may process the received result as it is or additionally to provide the requested functions or services. To achieve this, for example, cloud computing, distributed computing, or client-server computing technology may be used.

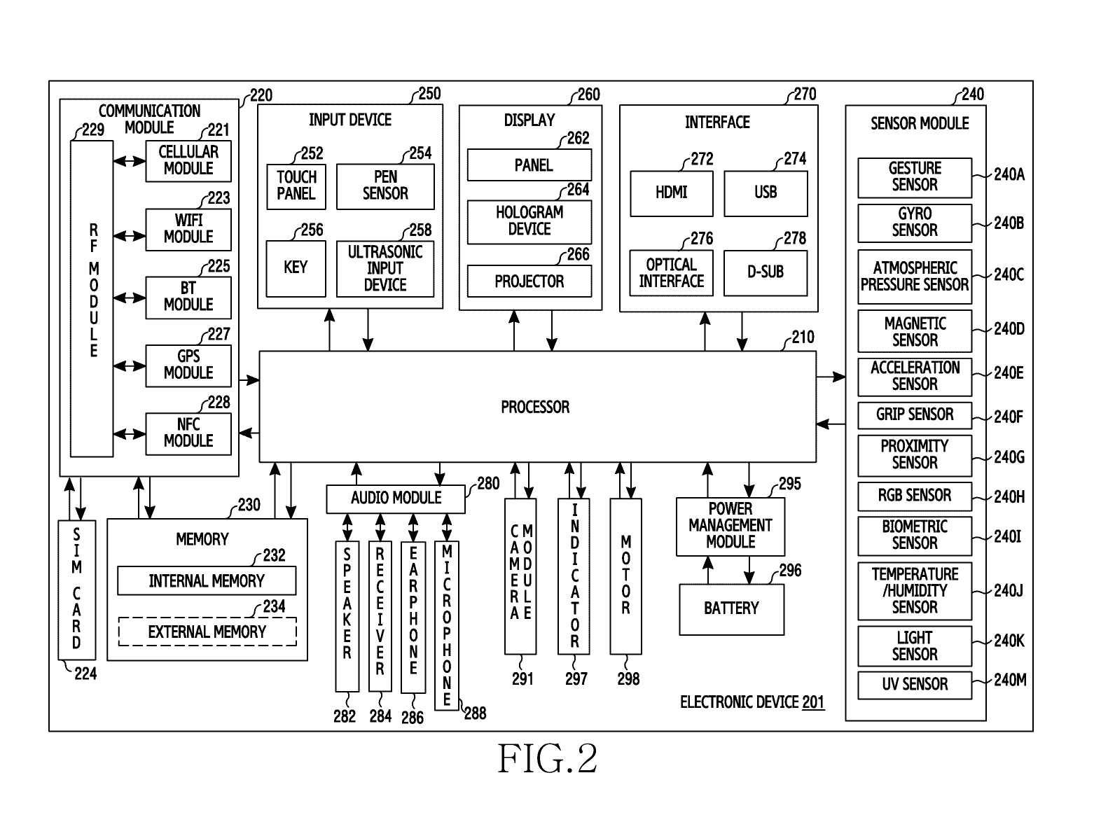

FIG. 2 is a block diagram of an electronic device 201 according to various embodiments of the present disclosure. The electronic device 201 may include, for example, all or a part of the electronic device 101 illustrated in FIG. 1. The electronic device 201 may include at least one processor (for example, AP) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

Referring to FIG. 2, the processor 210 may, for example, control a plurality of hardware or software elements connected thereto and perform a variety of data processing and calculations by driving an OS or application programs. The processor 210 may be implemented as, for example, a system on chip (SoC). According to an embodiment of the present disclosure, the processor 210 may further include a graphic processing unit (GPU) and/or an image signal processor (ISP). The processor 210 may include at least some of the elements (e.g., a cellular module 221) illustrated in FIG. 2. The processor 210 may load commands or data, received from at least one other element (e.g., a non-volatile memory), in a volatile memory to process the loaded commands or data, and may store various types of data in the non-volatile memory. The processor 210 may load, into a volatile memory, instructions or data received from at least one (for example, a non-volatile memory) of the other elements and may process the loaded instructions or data, and may store various data in a non-volatile memory.

According to an embodiment of the present disclosure, the processor 210 may control the display 260 or the audio module 280 to output the state change effect of the object based on the attribute of at least one object.

The communication module 220 may have a configuration equal or similar to that of the communication interface 170 of FIG. 1. The communication module 220 may include, for example, a cellular module 221, a Wi-Fi module 223, a Bluetooth (BT) module 225, a GNSS module 227 (e.g., a GPS module, a Glonass module, a Beidou module, or a Galileo module), an NFC module 228, and a Radio Frequency (RF) module 229.

The cellular module 221 may provide, for example, a voice call, a video call, a text message service, or an Internet service through a communication network. According to an embodiment of the present disclosure, the cellular module 221 may distinguish and authenticate the electronic device 201 in the communication network by using a SIM (e.g., the SIM card 224). According to an embodiment of the present disclosure, the cellular module 221 may perform at least some of the functions that the AP 210 may provide. According to an embodiment of the present disclosure, the cellular module 221 may include a CP.

The Wi-Fi module 223, the BT module 225, the GPS module 227, or the NFC module 228 may include, for example, a processor for processing data transmitted/received through the corresponding module. According to an embodiment of the present disclosure, at least some (e.g., two or more) of the cellular module 221, the Wi-Fi module 223, the BT module 225, the GPS module 227, and the NFC module 228 may be included in a single integrated chip (IC) or IC package.

The RF module 229 may, for example, transmit/receive a communication signal (e.g., an RF signal). The RF module 229 may include, for example, a transceiver, a power amp module (PAM), a frequency filter, a low noise amplifier (LNA), or an antenna. According to another embodiment of the present disclosure, at least one of the cellular module 221, the Wi-Fi module 223, the BT module 225, the GPS module 227, and the NFC module 228 may transmit/receive an RF signal through a separate RF module.

The SIM card 224 may include, for example, a card including a SIM and/or an embedded SIM, and may further include unique identification information (e.g., an integrated circuit card identifier (ICCID)) or subscriber information (e.g., international mobile subscriber identity (IMSI)).

The memory 230 may include, for example, an internal memory 232 or an external memory 234. The internal memory 232 may include, for example, at least one of a volatile memory (e.g., a dynamic random access memory (DRAM), a static RAM (SRAM), a synchronous DRAM (SDRAM), or the like) and a non-volatile memory (e.g., a one-time programmable read only memory (OTPROM), a PROM, an erasable and programmable ROM (EPROM), an electrically EPROM (EEPROM), a mask ROM, a flash ROM, a flash memory (e.g., a NAND flash memory or a NOR flash memory), a hard disc drive, or a solid state drive (SSD)).

The external memory 234 may further include a flash drive, for example, a compact flash (CF), a secure digital (SD), a, a Mini-SD, an extreme digital (xD), a memory stick, or the like. The external memory 234 may be functionally and/or physically connected to the electronic device 201 through various interfaces.

The sensor module 240 may, for example, measure a physical quantity or detect an operating state of the electronic device 201, and may convert the measured or detected information into an electrical signal. The sensor module 240 may include, for example, at least one of, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., red, green, and blue (RGB) sensor), a bio-sensor 240I, a temperature/humidity sensor 240J, an illumination sensor 240K, and a ultra violet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In an embodiment of the present disclosure, the electronic device 201 may further include a processor that is configured as a part of the AP 210 or a separate element from the AP 210 in order to control the sensor module 240, thereby controlling the sensor module 240 while the AP 2710 is in a sleep state.

The input device 250 may include, for example, a touch panel 252, a (digital) pen sensor 254, a key 256, or an ultrasonic input device 258. The touch panel 252 may use at least one of, for example, a capacitive type, a resistive type, an infrared type, and an ultrasonic type. In addition, the touch panel 252 may further include a control circuit. The touch panel 252 may further include a tactile layer to provide a tactile reaction to a user.

The (digital) pen sensor 254 may be, for example, a part of the touch panel, or may include a separate recognition sheet. The key 256 may include, for example, a physical button, an optical key, or a keypad. The ultrasonic input device 258 may identify data by detecting acoustic waves with a microphone (e.g., a microphone 288) of the electronic device 201 through an input unit for generating an ultrasonic signal.

The display 260 (e.g., the display 160) may include a panel 262, a hologram device 264, or a projector 266. The panel 262 may include a configuration that is the same as or similar to that of the display 160 of FIG. 1. The panel 262 may be implemented to be, for example, flexible, transparent, or wearable. The panel 262 may be configured as a single module integrated with the touch panel 252. The hologram device 264 may show a stereoscopic image in the air using interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a high-definition multimedia interface (HDMI) 272, a universal serial bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, an SD card/multi-media card (MMC) interface, or an infrared data association (IrDA) standard interface.

The audio module 280 may, for example, convert a sound into an electrical signal, and vice versa. At least some elements of the audio module 280 may be included in, for example, the input/output interface 150 illustrated in FIG. 1. The audio module 280 may, for example, process sound information that is input or output through the speaker 282, the receiver 284, the earphones 286, the microphone 288, or the like.

The camera module 291 may be, for example, a device that may take a still image or a moving image, and according to an embodiment of the present disclosure, the camera module 291 may include one or more image sensors (e.g., a front sensor or a rear sensor), a lens, an ISP, or a flash (e.g., a light emitting diode (LED) or a xenon lamp).

The power management module 295 may, for example, manage power of the electronic device 201. According to an embodiment of the present disclosure, the power management module 295 may include a power management integrated circuit (PMIC), a charger IC, or a battery or fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature during the charging. The battery 296 may include, for example, a rechargeable battery or a solar battery.

The indicator 297 may indicate a specific state of the electronic device 201 or a part thereof (e.g., the AP 210), for example, a booting state, a message state, a charging state, or the like. The motor 298 may convert an electrical signal into a mechanical vibration, and may generate a vibration or haptic effect. Although not illustrated, the electronic device 201 may include a processing unit (e.g., a GPU) for mobile TV support. The processing device for mobile TV support may, for example, process media data according to a standard of digital multimedia broadcasting (DMB), digital video broadcasting (DVB), media flow, or the like.

Each of the components of the electronic device according to the present disclosure may be implemented by one or more components and the name of the corresponding component may vary depending on a type of the electronic device. In various embodiments of the present disclosure, the electronic device may include at least one of the above-described elements. Some of the above-described elements may be omitted from the electronic device, or the electronic device may further include additional elements. Further, some of the elements of the electronic device according to various embodiments of the present disclosure may be coupled to form a single entity while performing the same functions as those of the corresponding elements before the coupling.

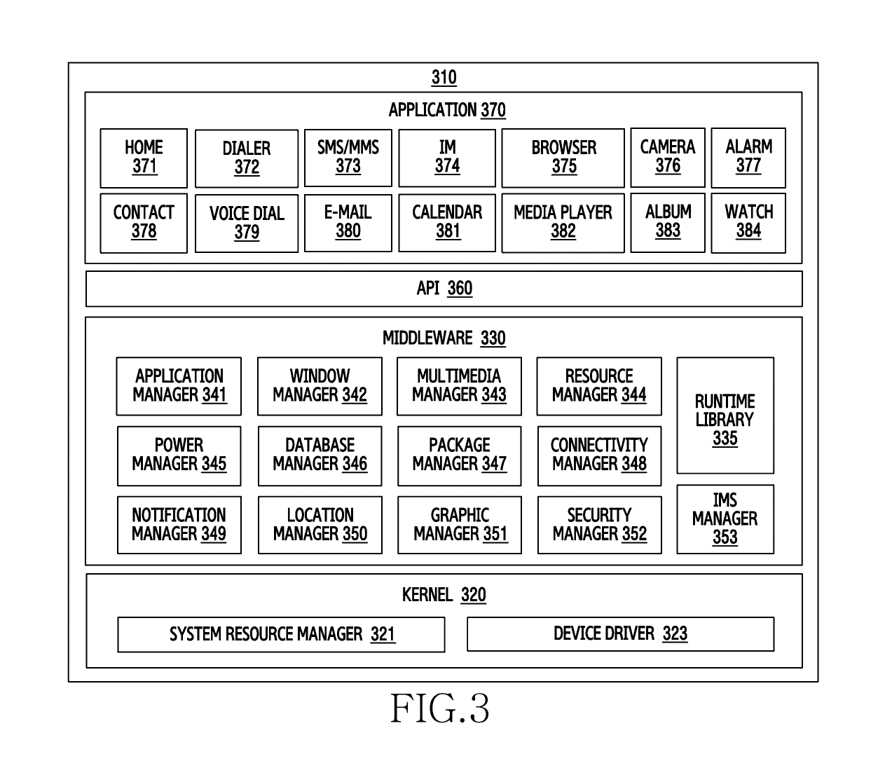

FIG. 3 is a block diagram of a program module 310 according to various embodiments of the present disclosure. According to an embodiment of the present disclosure, the program module 310 (e.g., the program 140) may include an OS that controls resources relating to an electronic device (e.g., the electronic device 101) and/or various applications (e.g., the application 147) executed in the OS. The OS may be, for example, Android, iOS™, Windows™, Symbian™, Tizen™, Bada™, or the like.

Referring to FIG. 3, the programming module 310 may include a kernel 320, middleware 330, an API 360, and/or applications 370. At least some of the program module 310 may be preloaded in the electronic device, or may be downloaded from an external electronic device (e.g., the electronic device (102, 104), the server 106).

The kernel 320 (e.g., the kernel 141 of FIG. 1) may include, for example, a system resource manager 321 or a device driver 323. The system resource manager 321 may control, allocate, or collect system resources. According to an embodiment of the present disclosure, the system resource manager 321 may include a process management unit, a memory management unit, or a file system management unit. The device driver 323 may include, for example, a display driver, a camera driver, a BT driver, a shared-memory driver, a USB driver, a keypad driver, a Wi-Fi driver, an audio driver, or an inter-process communication (IPC) driver.

The middleware 330 may provide, for example, a function commonly required by the applications 370, or may provide various functions to the applications 370 through the API 360 so that the applications 370 may efficiently use limited system resources within the electronic device. According to an embodiment of the present disclosure, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and an IMS manager 353.

The runtime library 335 may include a library module which a compiler uses in order to add a new function through a programming language while the applications 370 are being executed. The runtime library 335 may perform input/output management, memory management, the functionality for an arithmetic function, or the like.

The application manager 341 may manage, for example, a life cycle of at least one of the applications 370. The window manager 342 may manage graphical user interface (GUI) resources used for the screen. The multimedia manager 343 may determine a format required to reproduce various media files, and may encode or decode a media file by using a coder/decoder (codec) appropriate for the corresponding format. The resource manager 344 may manage resources, such as a source code, a memory, a storage space, and the like of at least one of the applications 370.

The power manager 345 may operate together with a basic input/output system (BIOS) to manage a battery or power, and may provide power information required for the operation of the electronic device. According to an embodiment of the present disclosure, the power manager 345 may perform a control so that a charge or discharge of a battery is provided through at least one of a wired manner and a wireless manner.

The database manager 346 may generate, search for, or change a database to be used by at least one of the applications 370. The package manager 347 may manage the installation or update of an application distributed in the form of a package file.

The connectivity manager 348 may manage a wireless connection such as, for example, Wi-Fi or BT. The notification manager 349 may display or notify of an event, such as an arrival message, an appointment, a proximity notification, and the like, in such a manner as not to disturb the user. The location manager 350 may manage location information of the electronic device. The graphic manager 351 may manage a graphic effect, which is to be provided to the user, or a user interface related to the graphic effect. The security manager 352 may provide various security functions required for system security, user authentication, and the like. The IMS manager 353 may provide multimedia services such as a voice, an audio, a video and data based on an Internet Protocol (IP).

According to an embodiment of the present disclosure, when the electronic device (for example, the electronic device 101) has a telephone call function, the middleware 330 may further include a telephony manager for managing a voice call function or a video call function of the electronic device.

The middleware 330 may include a middleware module that forms a combination of various functions of the above-described elements. The middleware 330 may provide a specialized module according to each OS in order to provide a differentiated function. Also, the middleware 330 may dynamically delete some of the existing elements, or may add new elements.

The API 360 (for example, the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (for example, the application programs 147) may include, for example, one or more applications which may provide functions such as a home 371, a dialer 372, a short messaging service (SMS)/multimedia messaging service (MMS) 373, an instant message (IM) 374, a browser 375, a camera 376, an alarm 377, contacts 378, a voice dialer 379, an email 380, a calendar 381, a media player 382, an album 383, a clock 384, health care (for example, measure exercise quantity or blood sugar), or environment information (for example, atmospheric pressure, humidity, or temperature information).

According to an embodiment of the present disclosure, the applications 370 may include an application (hereinafter, referred to as an “information exchange application” for convenience of description) supporting information exchange between the electronic device (for example, the electronic device 101) and an external electronic device (for example, the electronic device 102 or 104). The information exchange application may include, for example, a notification relay application for transferring specific information to an external electronic device or a device management application for managing an external electronic device.

For example, the notification relay application may include a function of transferring, to the external electronic device (for example, the electronic device 102 or 104), notification information generated from other applications of the electronic device (for example, an SMS/MMS application, an e-mail application, a health care application, or an environmental information application). Further, the notification relay application may, for example, receive notification information from the external electronic device and provide the received notification information to a user.

The device management application may manage (for example, install, delete, or update), for example, at least one function of an external electronic device (for example, the electronic device 102 or 104) communicating with the electronic device (for example, a function of turning on/off the external electronic device itself (or some elements) or a function of adjusting luminance (or a resolution) of the display), applications operating in the external electronic device, or services provided by the external electronic device (for example, a call service and a message service).

According to an embodiment of the present disclosure, the applications 370 may include applications (for example, a health care application of a mobile medical appliance) designated according to attributes of the external electronic device (for example, the electronic device 102 or 104). According to an embodiment of the present disclosure, the applications 370 may include an application received from the external electronic device (for example, the server 106, or the electronic device 102 or 104). According to an embodiment of the present disclosure, the applications 370 may include a preloaded application or a third party application which may be downloaded from the server. Names of the elements of the program module 310 according to the above-illustrated embodiments may change depending on the type of OS.

According to various embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process, for performing one or more functions.

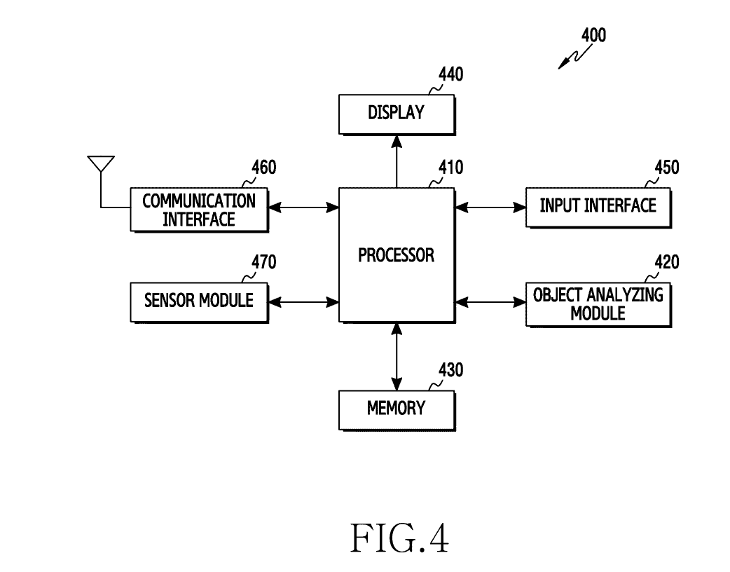

FIG. 4 illustrates an electronic device for outputting a state change effect according to various embodiments of the present disclosure.

Referring to FIG. 4, the electronic device 400 (e.g., the electronic device 101 of FIG. 1 or the electronic device 201 of FIG. 2) may include a processor 410 (e.g., including processing circuitry), an object analyzing module 420 (e.g., including object analyzing circuitry), a memory 430, a display 440 (e.g., including display circuitry), an input interface 450 (e.g., including input circuitry), a communication interface 460 (e.g., including communication circuitry) and a sensor module 470 (e.g., including sensor circuitry).

The electronic device 400 may include at least one processor 410 (e.g., the processor 120 of FIG. 1 or the processor 210 of FIG. 2). The processor 410 may include one or more of a CPU, an AP, and a CP.

When the processor 410 detects an input for the object, the processor 410 may output the state change effect corresponding to the attribute of the object. For example, the processor 410 may control the display to output the state change effect (e.g., a graphic effect) based on input information of the object and the attribute of the object provided from the object analyzing module 420. For example, the processor 410 may control an audio module (e.g., the audio module 280) to output the state change effect (e.g., an audio effect) based on the input information of the object and the attribute of the object provided from the object analyzing module 420. Additionally or alternatively, the processor 410 may control to output the state change effect additionally corresponding to at least one of background attribute or system information.

According to an embodiment of the present disclosure, when the input for the object is accumulated to a certain value or more, the processor 410 may control to output the state change effect for a corresponding object. For example, when at least one of the number of touch inputs, a consistent time of a touch input, a strength accumulation amount of the touch input, a distance accumulation amount of a touch drag, the number of direction changes of the touch drag or an accumulation amount of a direction change angle of the touch drag, a speed accumulation amount of the touch drag, and an accumulation amount of data input from the sensor module 470 is equal to or more a predetermined configuration value, the processor 410 may control to output the state change effect (e.g., a lock release) corresponding to the attribute of the object and an accumulation amount of the input information.

According to an embodiment of the present disclosure, when the processor 410 detects inputs of a plurality of objects, the processor 410 may control to output the state change effect corresponding to a relation and input information of the objects.

According to an embodiment of the present disclosure, when the input information of the object satisfies an event generation condition, the processor 410 may perform an operation corresponding to the event generation condition. For example, when the input information of the object satisfies a lock release condition, the processor 410 may release a lock. For example, when the input information of the object satisfies an application program execution condition, the processor 410 may execute a corresponding application program. For example, when the input information of the object satisfies a control function configuration condition, the processor 410 may configure a corresponding control function (e.g., configure a vibration mode).

According to an embodiment of the present disclosure, the processor 410 may determine an amount (or a size) of the event generation information for displaying the event generation information in the object such that the event generation information corresponds to the size of the object.

According to an embodiment of the present disclosure, when the processor 410 detects an input of an object displayed on the display 440, the processor 410 may control the display 440 to change a corresponding object to another object. Additionally, when the processor 410 detects an input for another object displayed on the display 440, the processor 410 may activate a function mapped to the object or the other object. Here, the other object may be a second object which may activate (e.g., trigger) a function mapped to a first object of which an input is detected.

The object analyzing module 420 may detect attributes for each of a plurality of objects included in an image. For example, the object analyzing module 420 may extract the plurality of objects included in the image by analyzing the image (e.g., a background image and a lock screen). The object analyzing module 420 may detect the attributes of each object by analyzing extracted objects. Specifically, the object analyzing module 420 may extract edge information of the image. The object analyzing module 420 may divide the image into a plurality of areas according to the extracted edge information, and may detect the attribute of the object included in each area by classifying the types of divided areas.

According to an embodiment of the present disclosure, the object analyzing module 420 may detect the attribute of the object selected by a user among the objects included in the image through the analysis for the image (e.g., the background image and the lock screen). Here, the object selected by the user may include an object including a coordinate in which a user input is detected.

According to an embodiment of the present disclosure, the object analyzing module 420 may configure an object list including information on the object (e.g., the object attribute). For example, the object list may include color information, coordinate information and size information of the object.

The memory 430 may store instructions or data related to elements configuring the electronic device. For example, the memory 430 may store at least one background image which may be displayed on the display 440, the attribute information of the object, data (or table), or an application program for providing an effect according to the state change of the object, etc.

The display 440 may display various types of contents (for example, text, images, videos, icons, or symbols) to the user. For example, the display 440 may provide a menu screen, and a graphic effect such as an effect display according to the object state change. For example, the display 440 may include a touch screen.

The input interface 450 may transfer, to other element(s) of the electronic device, an instruction or data for an operation control of the electronic device, which is input from a user or another external device. For example, the input interface 440 may include a key pad, a dome switch, a physical button, a touch pad (e.g., a static pressure manner or an electrostatic manner), a jog & shuttle, and the like. For example, the input interface 450 may receive an input (e.g., a user touch input, a hovering input, or the like) through the touch screen. The input interface 450 may transmit information on a position where the input is received to the processor 410 (or the object analyzing module 420).

The communication interface 460 may transmit or receive a signal between the electronic device 400 and an external device (e.g., another electronic device or a server). The communication interface 460 may include a cellular module and a non-cellular module. The non-cellular module may perform a communication between the electronic device 400 and another electronic device or the server using a short range wireless communication method. For example, the communication interface 460 may be connected to a network through a wireless communication or a wired communication to communicate with the external device.

The sensor module 470 may convert measurement information on a physical amount or sensing information on an operation state of the electronic device into an electrical signal, and may generate sensor data. For example, the sensor module 470 may detect an input for generating the state change of the object through at least one of a microphone, a gravity sensor, an acceleration sensor, an illuminance sensor, an image sensor (or a camera), a temperature sensor, a humidity sensor, and a wind sensing sensor.

According to various embodiments of the present disclosure, a whole function or at least some function of the object analyzing module 420 may be performed in the processor 410.

According to an embodiment of the present disclosure, the input information may include an input type and an input main agent (e.g., the electronic device 400 or the external device) related to the object. For example, the input type may include at least one of a touch for the object, a multi-touch, a flick, a long press, drag and drop, a circulation, and a drag. Additionally, the input type may further include any of a configured air gesture input (e.g., a hovering), and a hardware or software button input, in addition to an input using the touch screen.

According to an embodiment of the present disclosure, a background attribute may include a type, a color, or the like of the background image.

According to an embodiment of the present disclosure, the system information may include at least one of peripheral information and alarm information such as time information and weather information received by the electronic device 400, event information such as a message reception and an e-mail reception, and event information received from the external device (e.g., the electronic device 104 or the server 106). Here, the external device may include a wearable device. For example, the electronic device 400 may differentiate the input (e.g., a user input) through the electronic device 400 and the input (e.g., a user input) through the wearable device, and may differently provide the state change effect for the object such that the state change effect corresponds to each input.

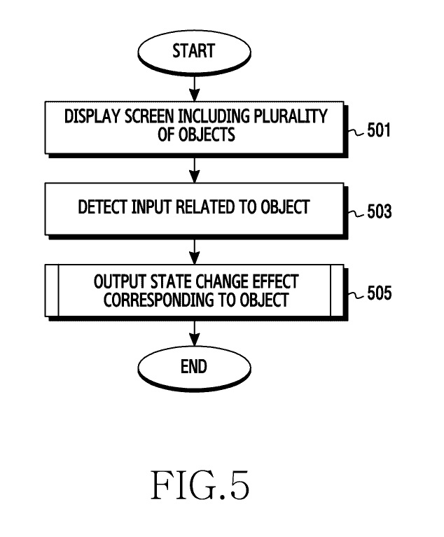

FIG. 5 illustrates a flowchart for outputting a state change effect corresponding to an object in an electronic device according to various embodiments of the present disclosure.

Referring to FIG. 5, in operation 501, the electronic device (e.g., the electronic device 101, 201 or 400) may display a screen including a plurality of objects on a display (e.g., the display 440). For example, the processor 410 may control the display 400 to display a lock screen or a background image including the plurality of objects.

In operation 503, the electronic device may detect an input related to at least one object. For example, the processor 410 may extract the objects by analyzing the screen displayed on the display 440. The processor 410 may detect an input for at least one object among the plurality of objects included in the screen displayed on the display 440 through the input interface 450 or the sensor module 470. For example, the processor 410 may receive the input for at least one object from the external device through the communication interface 460.

In operation 505, the electronic device may output the state change effect corresponding to a corresponding object, in response to the detection of the input related to the object. For example, the processor 410 may control at least one of the display 440 and the audio module to output the state change effect corresponding to the input information and the attribute of the object of which the input is detected. Additionally, the processor 410 may control at least one of the display 440 and the audio module to output the state change effect in consideration of the background attribute or the system information additionally.

According to an embodiment of the present disclosure, the electronic device may divide the background image and the object to form the background image and the object in different layers. The electronic device may output the state change effect of the object through the layer including the object, in response to the input detection for the object.

According to an embodiment of the present disclosure, the electronic device may output the state change effect of the object through the layer different from the layer including the background image and the object, in response to the input detection for the object.

According to an embodiment of the present disclosure, the electronic device may output a morphing effect which changes the object of which the input is detected to another object, as a state change effect of the corresponding object, in response to the input detection for the object.

According to an embodiment of the present disclosure, the electronic device may output a state change effect which changes a whole or at least some of the background image to another image, in response to the input detection for the object.

According to an embodiment of the present disclosure, the electronic device may output an animation effect corresponding to the object of which the input is detected as the state change effect of the corresponding object, in response to the input detection for the object.

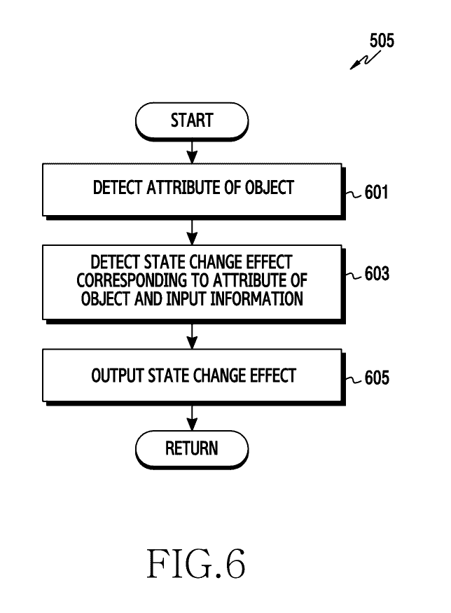

FIG. 6 illustrates a flowchart for outputting a state change effect based on an attribute of an object in an electronic device according to various embodiments of the present disclosure. Hereinafter, an operation for outputting the state change effect in step 505 of FIG. 5 is described.

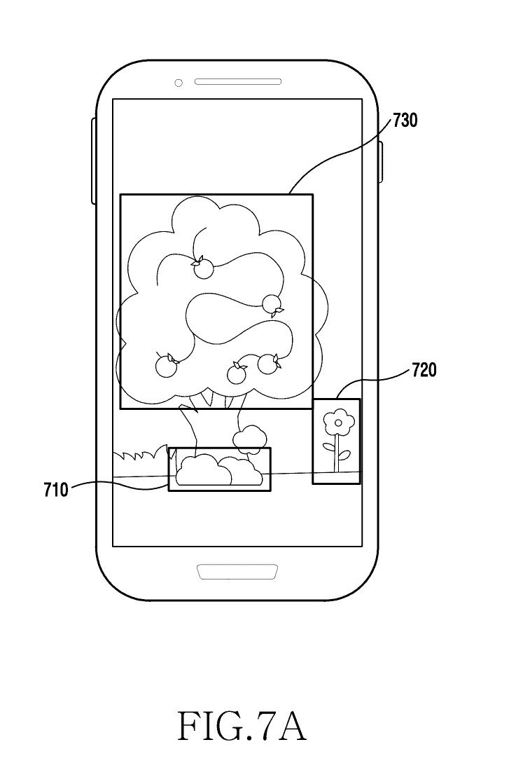

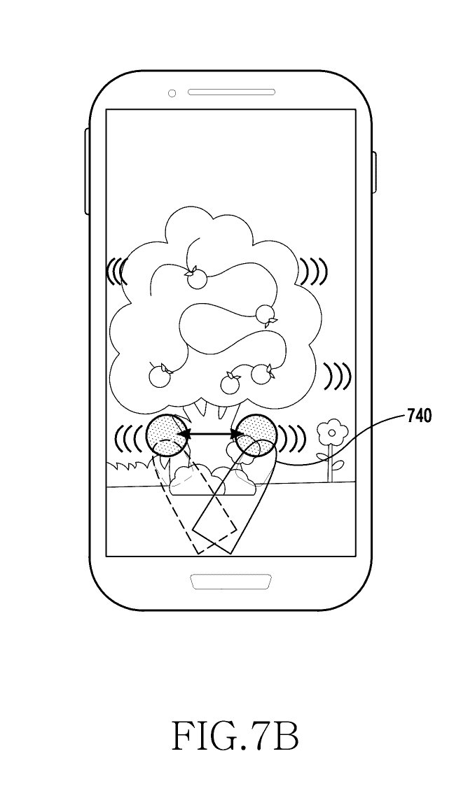

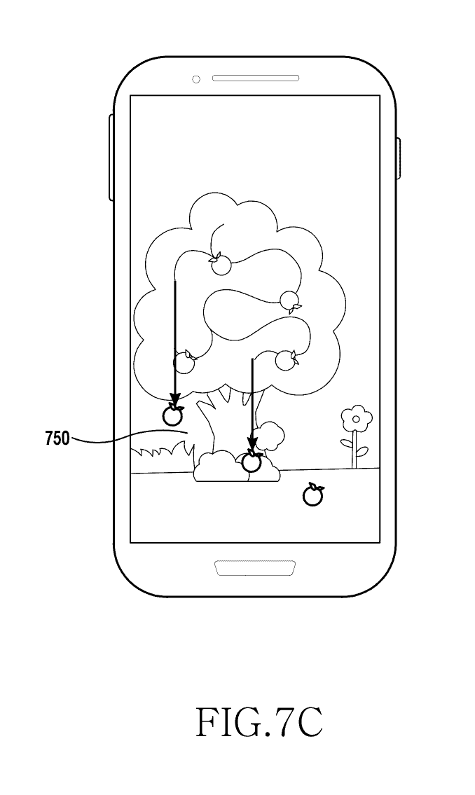

FIGS. 7A to 7C illustrate a screen configuration for outputting a state change effect based on an attribute of an object in an electronic device according to various embodiments of the present disclosure.

Referring to FIGS. 6 and 7A to 7C, in operation 601, the electronic device (e.g., the electronic device 101, 201 or 400) may detect the attribute of the object of which the input is detected. For example, the processor 410 may control the display 440 to display a background image including an object of a grass 710, a flower 720 and an apple tree 730 as shown in FIG. 7A. When the processor 410 detects an input (e.g., a drag) 740 for the apple tree object 730 through the input interface 450 as shown in FIG. 7B, the processor 410 may detect an attribute of the apple tree object 730. For example, the processor 410 may extract attribute information corresponding to a type of the apple tree object 730 in an object attribute table which is stored in the memory 430. For example, the processor 410 may receive the attribute information corresponding to the type of the apple tree object 730 from the external device through the communication interface 460.

In operation 603, the electronic device may detect the state change effect corresponding to the attribute of the object and the input information. For example, the processor 410 may detect the state change effect corresponding to the attribute of the object and the input information from the state change effect table stored in the memory 430. For example, the processor 410 may request and receive the state change effect corresponding to the attribute of the object and the input information from the external device (e.g., the server 106) through the communication interface 460.

In operation 605, the electronic device may output the state change effect corresponding to the attribute of the object and the input information. For example, the processor 410 may control the display 440 to output a state change effect in which the apple tree object 730 is shaken from side to side, in accordance with a left and right drag input 740 for the apple tree object 730 shown in FIG. 7B. When the drag input 740 (e.g., a drag distance) is higher than a reference value, the processor 410 may control the display 440 to output a state change effect 750 in which an apple is fallen from the apple tree object 730 as shown in FIG. 7C. For example, the processor 410 may control the display 440 to output a state change effect in which the grass object 710 grows or shakes, in accordance with an input (e.g., a touch) for the grass object 710. The processor 410 may control the audio module to output a sound (e.g., a rustling sound) in which the grass object 710 is stepped on, in accordance with the input (e.g., the touch) for the grass object 710. For example, the processor 410 may control the display 440 to output a state change effect in which the flower object 720 is broken or is in full bloom, in accordance with an input (e.g., a drag or a touch) for the flower object 720.

According to an embodiment of the present disclosure, the electronic device may output an additional state change effect as shown in FIG. 7C, based on a consistent time, a strength, a movement distance (e.g., a drag distance), a movement number, or the like of the input for the object.

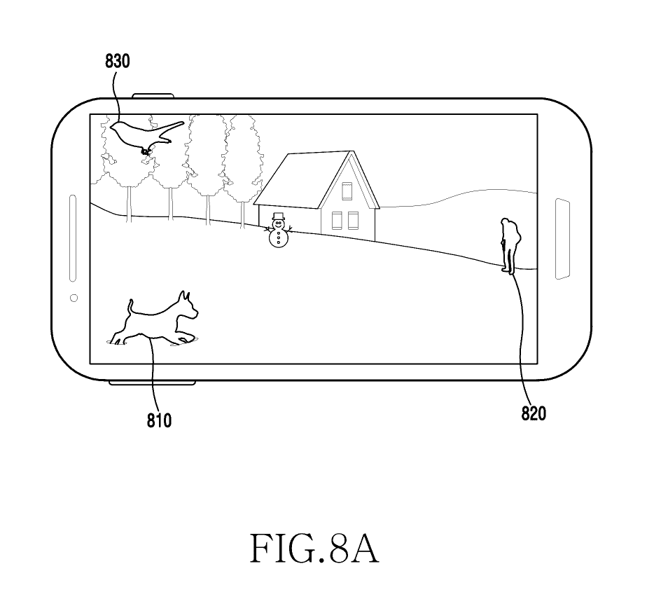

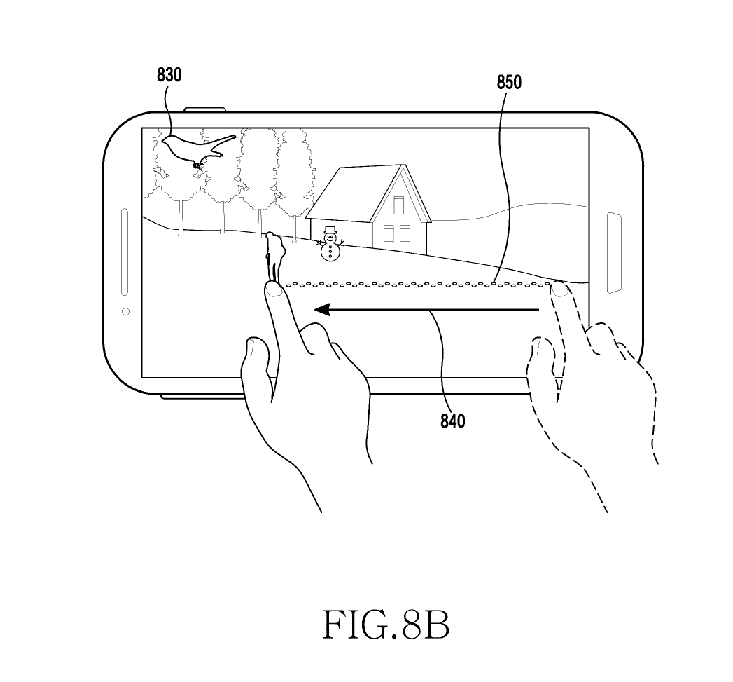

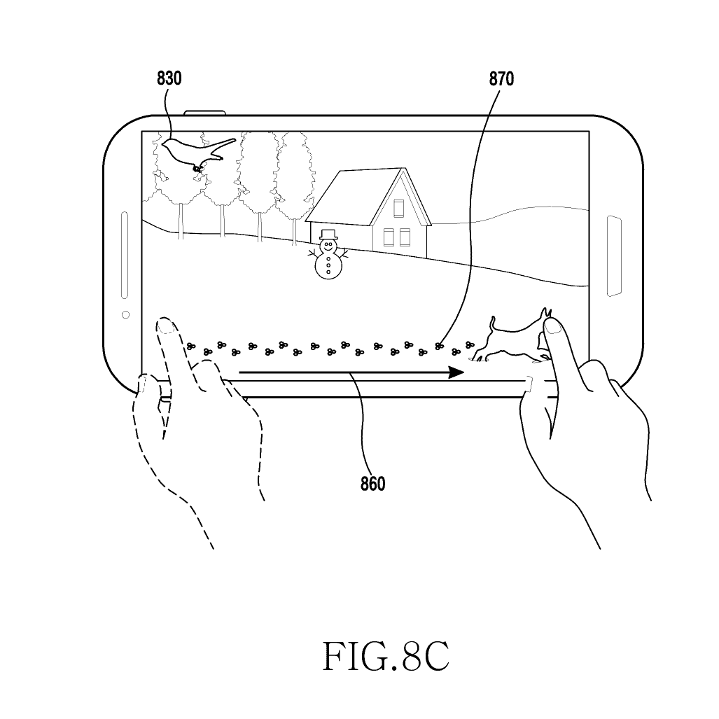

FIGS. 8A to 8C illustrate a screen configuration for outputting a state change effect corresponding to an object attribute in an electronic device according to various embodiments of the present disclosure. Hereinafter, an embodiment for outputting the state change effect of a corresponding object based on the attribute and the input information of the object as shown in FIG. 6 is described.

Referring to FIGS. 8A to 8C, an electronic device (e.g., the electronic device 101, 201 or 400) may display a lock screen including objects of a dog 810, a human 820 and a bird 830 on the display 440 as shown in FIG. 8A.

According to an embodiment of the present disclosure, when the electronic device detects a drag input 840 for the human object 820 as shown in FIG. 8B, the electronic device may detect the state change effect corresponding to an attribute and the input information 840 of the human object 820. For example, the processor 410 may detect the state change effect corresponding to the attribute of the human object 820 and a drag input 840 from a state change effect table shown in the following Table 1, which is stored in the memory 430.

TABLE 1

| Object | Characteristic | State change effect |
|---|---|---|
| Human | The human is far away. | Human footprint |
| | The speed of the human is | Small footprint |
| | slow. | Small stride |
| | | Breath |
| Dog | The dog is near. | Dog footprint |
| | The speed of the dog is | Large footprint |
| | fast. | Large stride |
| | | Bark |
| Bird | The bird is on a tree. | Shaking of tree |
| | The bird can fly. | Flying of the bird |
| | | Snow falling effect |
| | | Flying bird sound |

The electronic device may display the human footprint 850 of the small stride corresponding to the drag input 840 for the human object 820, on the display 440. Additionally, the electronic device may output a human breath corresponding to the drag input 840 for the human object 820 through a speaker.

According to an embodiment of the present disclosure, when the electronic device detects a drag input 860 for the dog object 810 as shown in FIG. 8C, the electronic device may display, on the display 440, the dog footprint 870 of the large stride corresponding to the drag input 860 for the dog object 810. Additionally, the electronic device may output the bark of the dog corresponding to the drag input 860 for the dog object 810, through the speaker.

According to an embodiment of the present disclosure, when the electronic device detects a drag input for the bird object 830, the electronic device may display an effect in which it looks like that the bird is flying, in accordance with the drag input for the bird object 830, on the display 440. Additionally, the electronic device may display a snow falling effect from the tree on which the bird object 830 has been disposed in accordance with the drag input for the bird object 830.

According to an embodiment of the present disclosure, when the distance of the drag input 840 or 860 for the object 810, 820, or 830 is longer than a reference value, the electronic device may release a lock of the electronic device. For example, the electronic device may release the lock with a security grade corresponding to at least one of the attribute of the object or the input information (e.g., the drag input). Here, the security grade may include a range of information, a function and an application program which may be used or accessed by a user.

According to various embodiments of the present disclosure, the electronic device may conceal a display of an object capable of providing the state change effect in the background image (e.g., the lock screen). For example, the electronic device may conceal the display of the objects of the dog 810, the human 820 and the bird 830 in a snow scene image of FIG. 8A. In this case, the electronic device may output the state change effect based on a start position of a user input for the snow scene image. For example, when the electronic device detects a drag input from a right side to a left side in the snow scene image of FIG. 8A, the electronic device may recognize that the electronic device detects the input for the human object 820. Thus, the electronic device may display, on the display as shown in FIG. 8B, the human footprint 850 of the small stride corresponding to the human object 820 and the input information.

For example, when the electronic device detects a drag input from a left side to a right side in the snow scene image of FIG. 8A, the electronic device may recognize that the electronic device detects the input for the dog object 810. Thus, the electronic device may display, on the display as shown in FIG. 8C, the dog footprint 870 of the large stride corresponding to the dog object 810 and the input information.

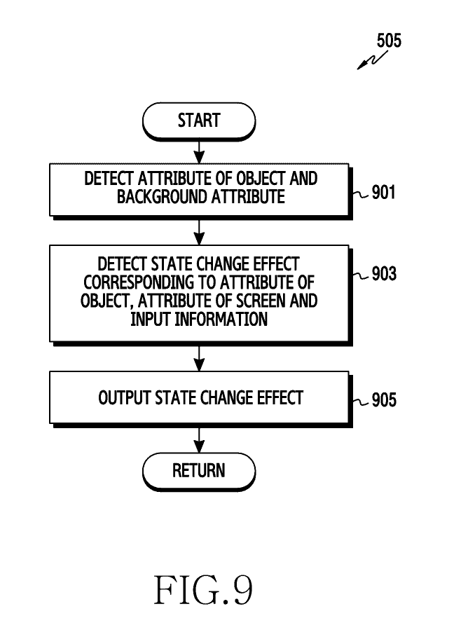

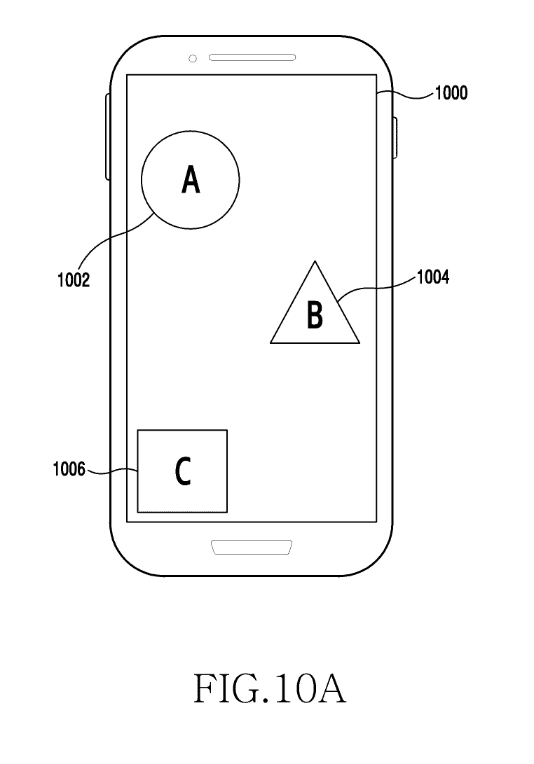

FIG. 9 illustrates a flowchart for outputting a state change effect based on an attribute of a screen in an electronic device according to various embodiments of the present disclosure. Hereinafter, an operation for outputting the state change effect in step 505 of FIG. 5 is described.

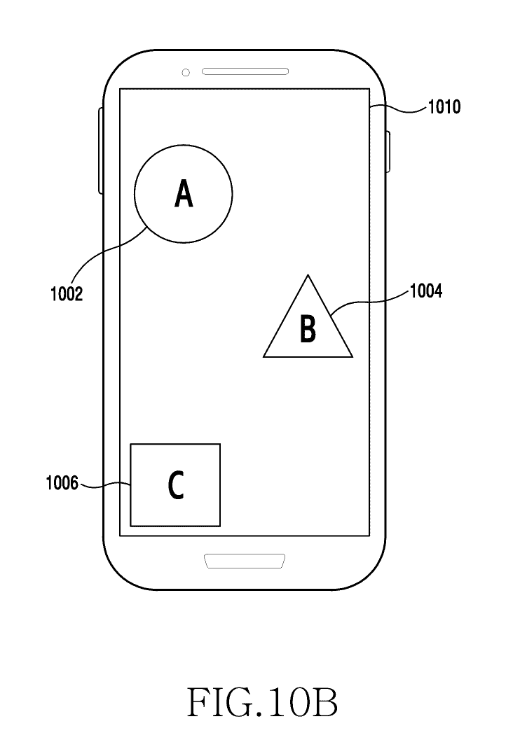

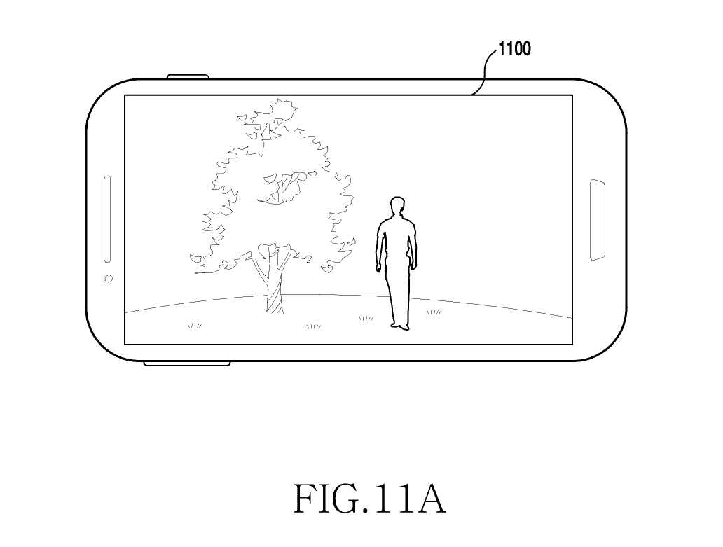

FIGS. 10A and 10B illustrate a screen configuration for outputting a state change effect based on an attribute of a screen in an electronic device according to various embodiments of the present disclosure.

Referring to FIGS. 9 and 10A to 10C, in operation 901, an electronic device (e.g., the electronic device 101, 201 or 400) may detect an attribute (hereinafter, referred to as a background attribute) of an object of which an input is detected and an attribute of the background image. For example, the processor 410 may extract an object A 1002, an object B 1004 and an object C 1006 by analyzing a background image 1000 displayed on the display 440 as shown in FIG. 10A. The processor 410 may detect the attribute of each object 1002, 1004 or 1006 and the attribute of the background image 1000.

In operation 903, the electronic device may detect a state change effect corresponding to an attribute of the object, a background attribute and input information. For example, the processor 410 may detect the state change effect corresponding to the attribute of the object, the background attribute and the input information, from a state change effect table stored in the memory 430. For example, the processor 410 may transmit the attribute of the object, the background attribute and the input information to an external device (e.g., the server 106) through the communication interface 460. The processor 410 may receive the state change effect corresponding to the attribute of the object, the background attribute and the input information from the external device through the communication interface 460.

In operation 905, the electronic device may output the state change effect corresponding to the attribute of the object, the background attribute and the input information. For example, in the case of FIG. 10A, the processor 410 may control to output a first state change effect based on a selection of the object A 1002, to output a second state change effect based on a selection of the object B 1004, and to output a third state change effect based on a selection of the object C 1006. When the attribute 1010 (e.g., the color) of the background image is changed as shown in FIG. 10B, the processor 410 may control to output a fourth state change effect based on the selection of the object A 1002, to output a fifth state change effect based on the selection of the object B 1004, and to output a sixth state change effect based on the selection of the object C 1006.

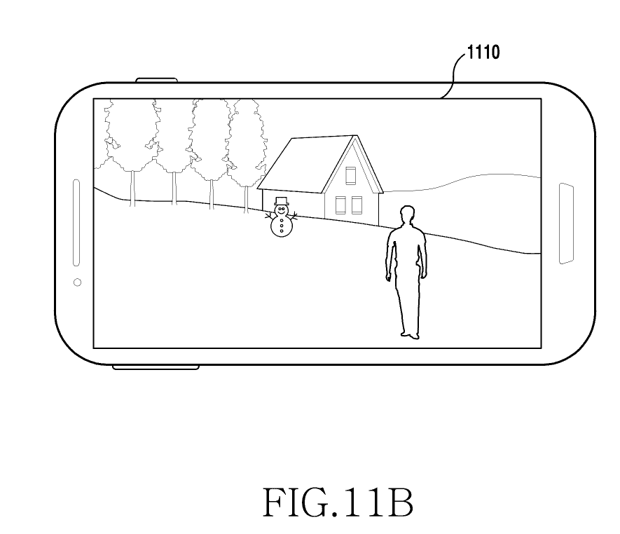

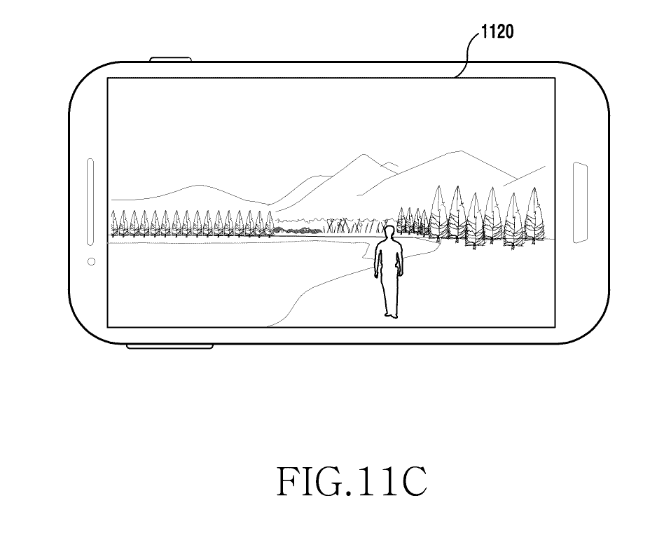

FIGS. 11A to 11C illustrate a screen configuration for outputting a state change effect corresponding to a screen attribute in an electronic device according to various embodiments of the present disclosure. Hereinafter, a technique for outputting a state change effect of a corresponding object based on the attribute of the object, the background attribute and the input information as shown in FIG. 9 is described.

Referring to FIGS. 11A to 11C, an electronic device (e.g., the electronic device 101, 201 or 400) may display, on a display (e.g., the display 440), a grassland image 1100 as shown in FIG. 11A, a snow scene image 1110 as shown in FIG. 11B, or a beach image 1120 as shown in FIG. 11C.

According to an embodiment of the present disclosure, the electronic device may detect the state change effect corresponding to the human object and each background attribute from a state change effect table as shown in the following Table 2.

TABLE 2

| Object | Background image | State change effect |
|---|---|---|
| Human | Grassland | Movement speed: fast |
| | | Grass stepped sound, Wind sound |
| | | and the like |
| | Snow scene | Movement speed: very slow |
| | | Snow falling effect, breath sound, |
| | | breath display, |
| | | footprint display on snowy road |
| | Beach | Movement speed: slow |
| | | Wave sound, swimming figure, |
| | | beach walking figure, |
| | | footprint display of seaside |

According to an embodiment of the present disclosure, when the electronic device detects a touch input for the human object displayed in the grassland image 1100 as shown in FIG. 11A, the electronic device may output at least one of the grass stepped sound and the wind sound corresponding to the grassland image 1100 through a speaker.

According to an embodiment of the present disclosure, when the electronic device detects a drag input for the human object displayed in the snow scene image 1110 as shown in FIG. 11B, the electronic device may display the footprint on the snowy road corresponding to the snow scene image 1110 and the drag input.

According to an embodiment of the present disclosure, when the electronic device detects a drag input for the human object displayed in the beach image 1120 as shown in FIG. 11C, the electronic device may display the footprint in the seaside corresponding to the beach image 1120 and the drag input.

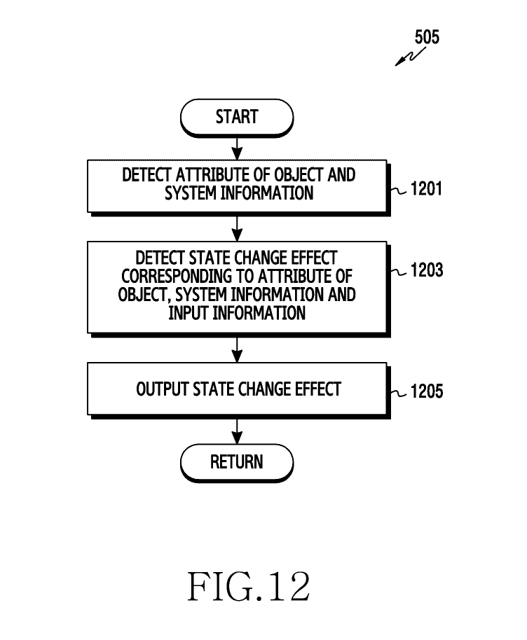

FIG. 12 illustrates a flowchart for outputting a state change effect based on a system attribute in an electronic device according to various embodiments of the present disclosure.

Referring to FIG. 12, in operation 1201, an electronic device (e.g., the electronic device 101, 201 or 400) may detect an attribute of an object of which an input is detected and system information. For example, the processor 410 may extract a plurality of objects included in a background image by analyzing the background image displayed on the display 440. The processor 410 may detect the attributes of each object from the object attribute table of the memory 430. For example, the processor 410 may detect system information (e.g., time, weather, season, or the like) of the time point when the input of the object is detected.

In operation 1203, the electronic device may detect the state change effect corresponding to the attribute of the object, the system information and the input information. For example, the electronic device may detect the state change effect corresponding to the attribute of the object, the system information and the input information from the state change effect table stored in the memory 430 as shown in the following Table 3.

TABLE 3

| Object | System information | System change effect |
|---|---|---|
| Tree | Season | Spring: leaves have started to grow. |
| | | Summer: tree has started to bear fruit. |
| | | Autumn: tree has started to turn red. |
| | | Winter: leaves has fallen and snow is |
| | | accumulated. |
| Cloud | Weather | Rain: cloud becomes dark could and it |
| | | rains. |
| | | Wind: cloud moves |
| | | Snow: it has started to snow from cloud. |
| | | Sunny: cloud has gradually disappeared. |
| Sun | Time | Dawn: the sun starts to rise. |
| | | Day: the sun shines brightly. |
| | | Afternoon: the sun starts to set. |
| | | Night: the sun set and the moon rises. |

In operation 1205, the electronic device may output the state change effect corresponding to the attribute of the object, the system information and the input information. For example, when the processor 410 detects a touch input for a tree object, the processor 410 may control the display 440 to output a state change effect in which the tree has turned red, corresponding to the system information (e.g., autumn).

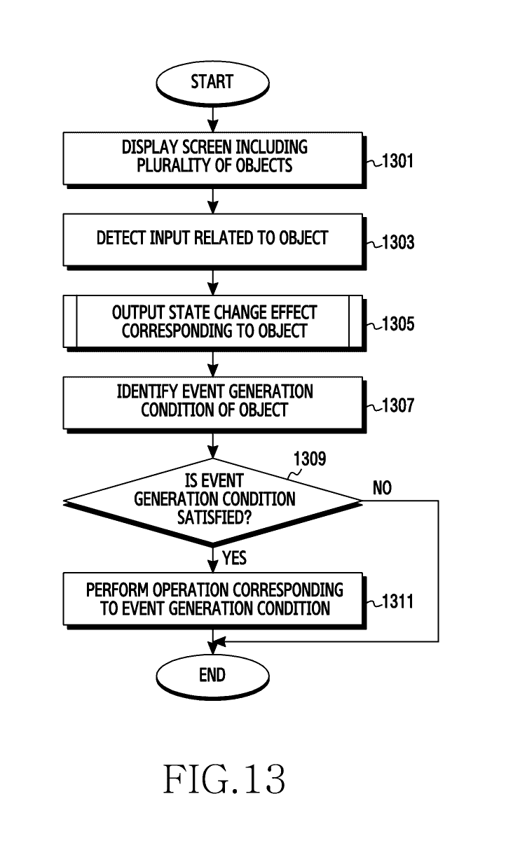

FIG. 13 illustrates a flowchart for performing an operation corresponding to an event generation condition of an object in an electronic device according to various embodiments of the present disclosure.

Referring to FIG. 13, in operation 1301, an electronic device (e.g., the electronic device 101, 201 or 400) may display, on a display (e.g., the display 440), a screen including a plurality of objects. For example, the processor 410 may control the display 440 to display the background image including the grass object 710, the flower object 720, and the apple tree object 730 as shown in FIG. 7A.

In operation 1303, the electronic device may detect an input related to at least one object among the objects displayed on the display. For example, the processor 410 may detect the drag input 740 for the apple tree object 730 through the input interface 450 as shown in FIG. 7B.

In operation 1305, the electronic device may output the state change effect corresponding to the attribute of the corresponding object in response to the detection of the input related to the object. For example, the processor 410 may control the display 440 to output the state change effect in which the apple tree object 730 is shaken from side to side, corresponding to the drag input 740 for the apple tree object 730.

In operation 1307, the electronic device may identify an event generation condition of the object. For example, the processor 410 may identify an event generation condition (e.g., a drag distance) matched with the apple tree object 730 in the memory 430 in response to the detection of the input related to the apple tree object 730.

In operation 1309, the electronic device may check whether the input information related to the object satisfies the event generation condition of the corresponding object. For example, the processor 410 may check whether the drag distance for the apple tree object 730 is longer than a reference drag distance configured as the event generation condition.

In operation 1311, when the input information related to the object satisfies the event generation condition of the corresponding object, the electronic device may perform an operation corresponding to the event generation condition. For example, when the input for the apple tree object 730 satisfies the event generation condition, the processor 410 may perform an operation such as a release of a lock screen or an execution of an application program mapped to the apple tree object 730.

According to various embodiments of the present disclosure, an electronic device may include a touch screen display, a processor electrically connected to the display, and a memory electrically connected to the processor. The memory may store instructions enabling the processor to display a background image including a first object and a second object as a lock screen on the display, to extract the first object and the second object in the background image, to receive a touch or a gesture input related to the first object or the second object through the display, to display a first visual effect on the screen when the processor receives an input related to the first object, and to display a second visual effect on the screen when the processor receives an input related to the second object.

According to various embodiments of the present disclosure, the instructions may enable the processor to obtain first information related to a first attribute of the first object and second information related to a second attribute of the second object from the memory, and to determine at least one condition based on at least some of the relations of the first attribute and the second attribute.

According to various embodiments of the present disclosure, the instructions may include instructions enabling the processor to execute a first action when a first movement of the first object by the input related to the first object or a second movement of the second object by the input related to the second object satisfies at least one condition, and to execute a second action when the first movement or the second movement does not satisfy at least one condition.

According to various embodiments of the present disclosure, the first action may be a lock release of the screen.

According to various embodiments of the present disclosure, the first action may be an execution of an application program corresponding to information of each object.

According to various embodiments of the present disclosure, the instructions may include instructions enabling the processor to display a third visual effect on the screen when the processor receives the input related to the first object and the input related to the second object.

According to various embodiments of the present disclosure, the third visual effect may be determined based on a relation of the attribute of the first object and the attribute of the second object.

According to various embodiments of the present disclosure, the first visual effect may be determined based on at least one of the attribute of the first object, an attribute of the lock screen, and system information.

According to various embodiments of the present disclosure, a method of operating an electronic device may include displaying a background image including a first object and a second object as a lock screen on a display of the electronic device, extracting the first object and the second object in the background image, receiving a touch or a gesture input related to the first object or the second object, displaying a first visual effect on the screen when an input related to the first object is received, and displaying a second visual effect on the screen when an input related to the second object is received.

According to various embodiments of the present disclosure, the method may further include obtaining first information related to a first attribute of the first object and second information related to a second attribute of the second object from the memory, and determining at least one condition based on at least some of a relation of the first attribute and the second attribute.

According to various embodiments of the present disclosure, the method may further include executing a first action when a first movement of the first object by the input related to the first object or a second movement of the second object by the input related to the second object satisfies at least one condition, and executing a second action when the first movement or the second movement does not satisfy at least one condition.

According to various embodiments of the present disclosure, the executing the first action may include releasing a lock screen.

According to various embodiments of the present disclosure, the executing the first action may include executing an application program corresponding to the first object or the second object.

According to various embodiments of the present disclosure, the method may further include displaying a third visual effect on the screen when the input related to the first object and the input related to the second object are received.

According to various embodiments of the present disclosure, the third visual effect may be determined based on a relation of the attribute of the first object and the attribute of the second object.

According to various embodiments of the present disclosure, the first visual effect may be determined based on at least one of the attribute of the first object, an attribute of the lock screen, and system information.

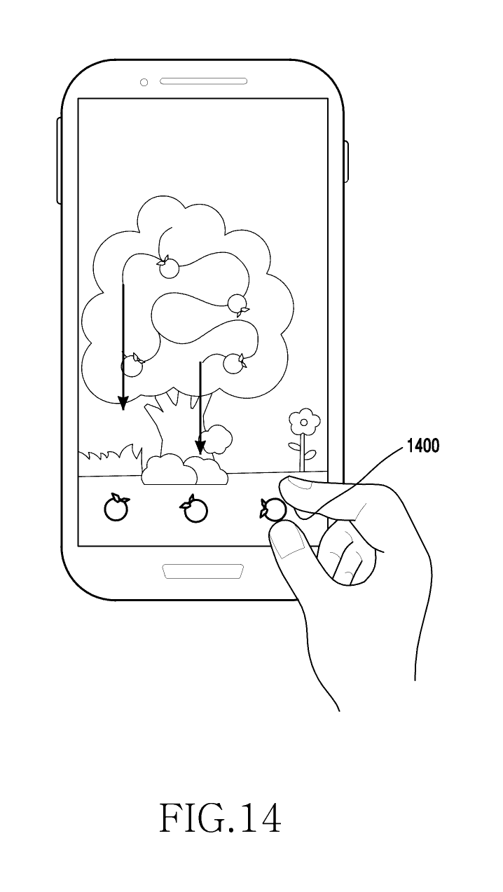

FIG. 14 illustrates a screen configuration for performing an operation corresponding to an event generation condition of an object in an electronic device according to various embodiments of the present disclosure.

Referring to FIG. 14, an electronic device (e.g., the electronic device 101, 201 or 400) may display a state change effect 750 in which an apple has fallen from the apple tree object 730 when the drag input 740 (e.g., the drag distance) for the apple tree object 730 is higher than a reference value as shown in FIG. 7C. In a case 1400 wherein the electronic device detects an input corresponding to an action in which a person picks up an apple, the electronic device may perform an operation mapped to the apple object. For example, different operations may be mapped to each apple object displayed on the display. Here, the input corresponding to the action in which the person picks up the apple may include a pinch-out input for the apple object. The operation mapped to the apple object may include a lock release, an application program execution, a control function configuration, or the like.

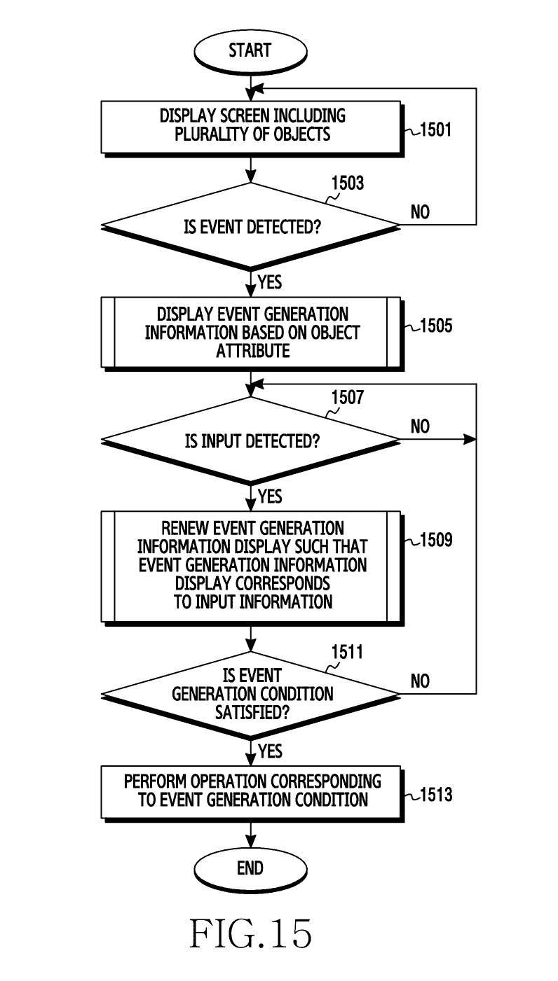

FIG. 15 illustrates a flowchart for outputting a state change effect corresponding to an event generation in an electronic device according to various embodiments of the present disclosure.

Referring to FIG. 15, in operation 1501, an electronic device (e.g., the electronic device 101, 201 or 400) may display a screen including a plurality of objects on a display (e.g., the display 440). For example, the processor 410 may control the display 440 to display a background image (e.g., a lock screen) including the plurality of objects.

In operation 1503, the electronic device may check whether an event generation is detected. For example, the processor 410 may check whether an event such as a call reception, a message reception, and an alarm generation is generated.

When the electronic device cannot detect the event generation, in operation 1501, the electronic device may maintain the display of the screen including the plurality of objects.

In operation 1505, the electronic device may display event generation information on the display based on an object attribute. For example, the processor 410 may detect an object that may display the event generation information among the objects included in the screen. The processor 410 may identify the size of the object that may display the event generation information. The processor 410 may display the event generation information corresponding to the size of the object.

In operation 1507, the electronic device may check whether an input for the object in which the event generation information is displayed is detected. For example, the processor 410 may check whether the input for the object in which the event generation information is displayed is detected through the input interface 450 or the communication interface 460.

In operation 1509, when the electronic device detects the input for the object in which the event generation information is displayed, the electronic device may renew the display of the event generation information in accordance with the input information. For example, the processor 410 may change (e.g., expand) the size of the object such that the size corresponds to the input for the object in which the event generation information is displayed. The processor 410 may renew the display of the event generation information such that the display corresponds to the changed size of the object.

In operation 1511, the electronic device may check whether the input information on the object satisfies the event generation condition of a corresponding object. For example, the processor 410 may check whether a touch number for the object in which the event generation information is displayed is more than a reference touch number configured as the event generation condition.

When the input information on the object does not satisfy the event generation condition of the corresponding object, in operation 1507, the electronic device may check whether the input for the object in which the event generation information is displayed is detected.

In operation 1513, when the input information on the object satisfies the event generation condition of the corresponding object, the electronic device may perform an operation corresponding to the event generation condition. For example, when the input information on the object satisfies the event generation condition of the corresponding object, the processor 410 may execute an application program corresponding to the event detected in operation 1503.

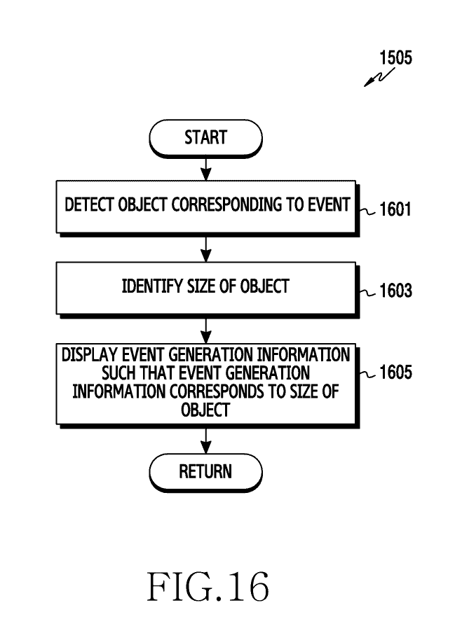

FIG. 16 illustrates a flowchart for displaying event generation information based on an object size in an electronic device according to various embodiments of the present disclosure. Hereinafter, an operation for displaying the event generation information in step 1505 of FIG. 15 is described.

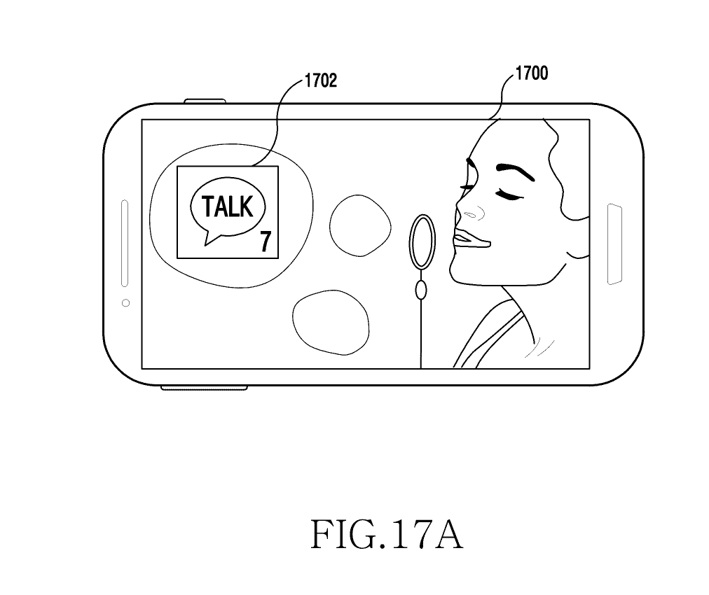

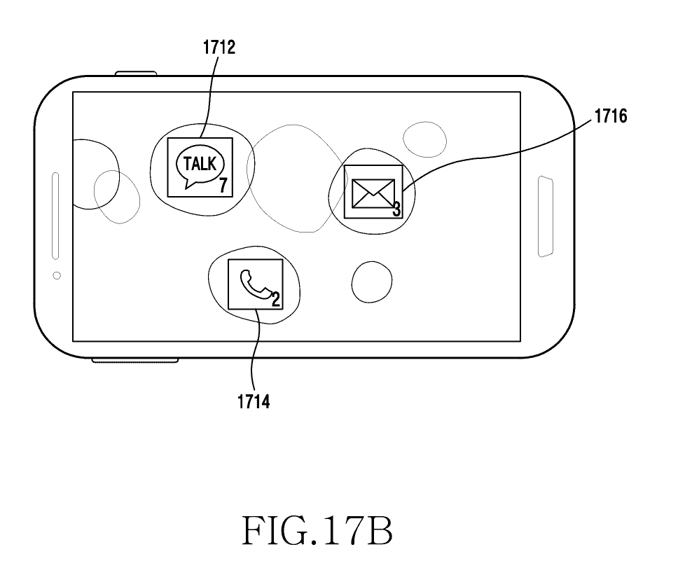

FIGS. 17A and 17B illustrate a screen configuration for displaying event generation information based on an object size in an electronic device according to various embodiments of the present disclosure.

Referring to FIGS. 16, 17A and 17B, in operation 1601, an electronic device (e.g., the electronic device 101, 201 or 400) may detect an object which may display the event generation information among objects displayed on a display. For example, the processor 410 may select a bubble 1702 for displaying the event generation information among bubbles of a background image 1700 displayed on the display 440 as shown in FIG. 17A.

In operation 1603, the electronic device may identify the size of the object for displaying the event generation information. For example, the processor 410 may identify the size of the bubble 1702 for displaying the event generation information in FIG. 17A.

In operation 1605, the electronic device may display the event generation information such that the event generation information corresponds to the size of the object. For example, the processor 410 may change or generate the event generation information such that the event generation information corresponds to the size of the object 1702 for displaying the event information. The processor 410 may display the event generation information (e.g., an icon of an application program corresponding to an event) in the corresponding object 1702 as shown in FIG. 17A. For example, the processor 410 may display a plurality of pieces 1712, 1714 and 1716 of event information which are not identified by a user in different objects as shown in FIG. 17B.

According to an embodiment of the present disclosure, the electronic device may change the size of the object in which the event generation information is displayed such that the size corresponds to an event generation number. For example, the electronic device may display the object (e.g., a bubble) 1712 displaying event generation information on seven event generations largely compared to the object (e.g., a bubble) 1714 displaying event generation information on two event generations. For example, the electronic device may display the event generation information on seven event generations in the object 1712 larger than the object 1714 displaying the event generation information on two event generations.

According to various embodiments of the present disclosure, when the electronic device detects the event generation, the electronic device may generate the bubble object 1702 corresponding to the event in the background image 1700 of FIG. 17A. The electronic device may display the event generation information in the bubble 1702 generated as shown in FIG. 17A. For example, the electronic device may display a background image including a human image for generating the bubble on a display. When the electronic device detects the event generation, the electronic device may further display the bubble object 1702 on the display. The electronic device may display the event generation information in the bubble object 1702 as shown in FIG. 17A. Additionally, when the electronic device detects an input (e.g., a touch input for the object) for identifying the event generation information displayed in the bubble object 1702, the electronic device may output a state change effect in which it looks like the bubble 1702 pops. For example, the electronic device may display the background image including the human image for generating the bubble on the display. When the electronic device detects a user input (e.g., a touch input for the human image) for identifying the event generation, the electronic device may further display the bubble object 1702 including the event generation information on the display as shown in FIG. 17A.

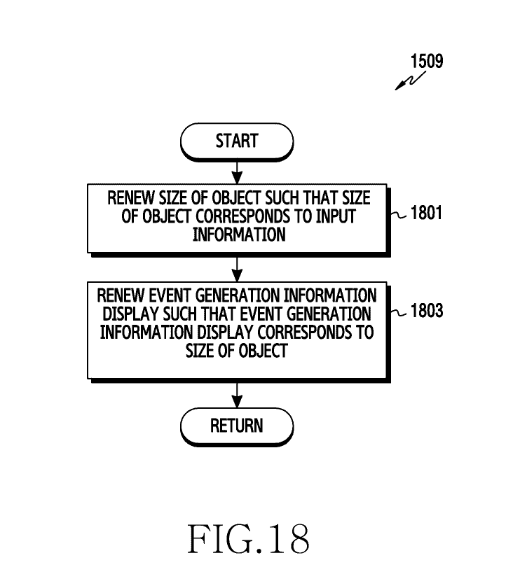

FIG. 18 illustrates a flowchart for displaying event generation information based on a renewed size of an object in an electronic device according to various embodiments of the present disclosure. Hereinafter, an operation for renewing the display of the event generation information in step 1509 of FIG. 15 is described.

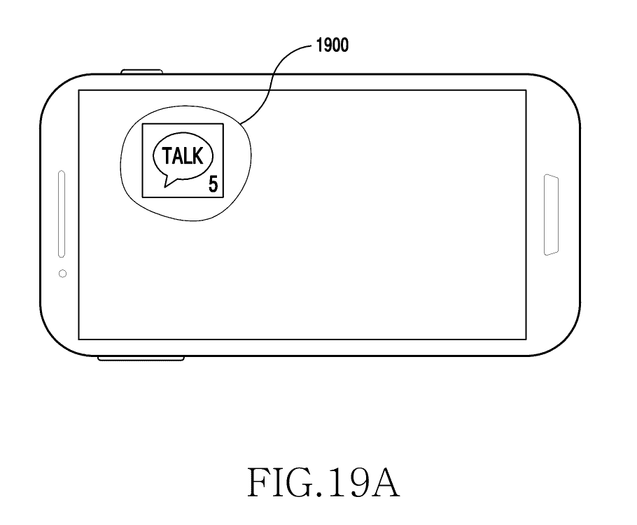

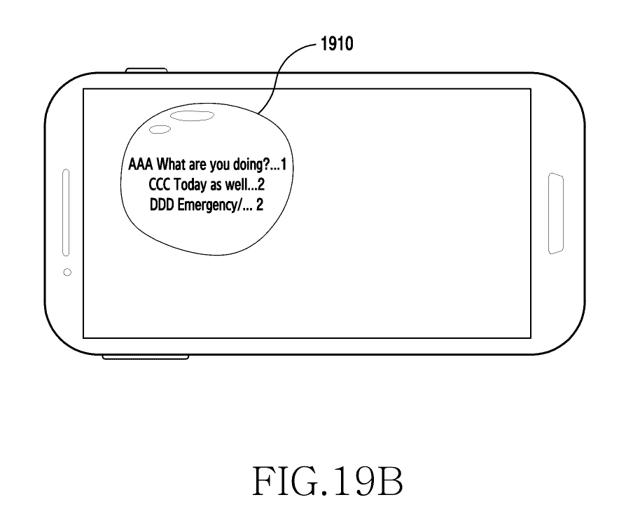

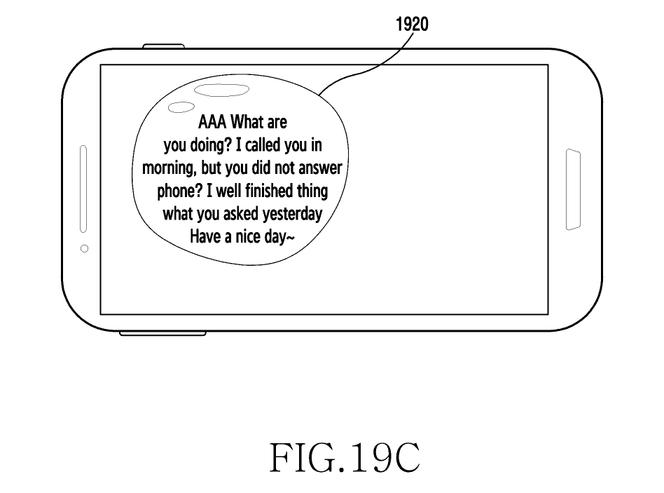

FIGS. 19A to 19C illustrate a screen configuration for displaying event generation information based on a renewed size of an object in an electronic device according to various embodiments of the present disclosure.

Referring to FIGS. 18 and 19A to 19C, in operation 1801, an electronic device (e.g., the electronic device 101, 201 or 400) may renew the size of a corresponding object such that the size corresponds to input information on the object in which the event generation information is displayed. For example, when the processor 410 detects the input for the object in which the event generation information is displayed, the processor 410 may expand the size of the object in which the event generation information is displayed. For example, the processor 410 may expand the size of the object in which the event generation information is displayed, to the size corresponding to the input information.

In operation 1803, the electronic device may renew the event generation information displayed in the object such that the event generation information corresponds to the renewed size of the object. For example, in operation 1505, the processor 410 may control the display 440 to display an icon of a messenger program corresponding to the event in an object 1900, such that the icon corresponds to the size of the object 1900 for displaying the event information, as shown in FIG. 19A. In addition, the object 1900 may display the number of unconfirmed messages in the messenger program corresponding to the event. For example, the processor 410 may control 1910 the display 440 to expand the size of the object 1900 in response to a touch input for the object 1900 as shown in FIG. 19B. In this case, the processor 410 may control the display 440 to display some contents of the unconfirmed message of the messenger program such that some contents correspond to the expanded size of the object 1910. For example, the processor 410 may control 1920 the display 440 to expand the size of the object 1910 in response to the touch input for the object 1910 as shown in FIG. 19C. In this case, the processor 410 may control the display 440 to display unconfirmed message contents in the object 1920 such that the unconfirmed message contents correspond to the expanded size of the object 1920.

According to various embodiments of the present disclosure, an electronic device may include a touch screen display, a processor electrically connected to the display, and a memory electrically connected to the processor. The memory may store instructions enabling the processor to provide a state in which the processor receives a touch input through only a selected area of the screen, while displaying a screen including a first object of a first size, on a substantial whole of the display, to display a first amount of first contents in the first object on the display, to change the first object to a second size different from the first size on the display, and to display a second amount of the first contents or second contents related to the first contents in the first object of the second size on the display, when the instructions are executed.

According to various embodiments of the present disclosure, the instructions may include instructions enabling the processor to change the first object to the second size different from the first size when the processor detects an input for the first object.

According to various embodiments of the present disclosure, the screen may include a lock screen.

According to various embodiments of the present disclosure, the instructions may include instructions enabling the processor to execute a first action when a first movement of the first object by the input related to the first object satisfies at least one condition.

According to various embodiments of the present disclosure, the first action may be an execution of an application program related to the first contents or the second contents.

According to various embodiments of the present disclosure, a method of operating an electronic device may include displaying a screen including a first object of a first size, on a substantial whole of a display of the electronic device, displaying a first amount of first contents in the first object on the display, changing the first object to a second size different from the first size on the display, and displaying a second amount of the first contents or second contents related to the first contents in the first object of the second size on the display.

According to various embodiments of the present disclosure, the changing to the second size different from the first size may include changing the first object to the second size different from the first size when an input for the first object is detected.

According to various embodiments of the present disclosure, the screen may include a lock screen.

According to various embodiments of the present disclosure, the method may include executing a first action when a first movement of the first object by the input related to the first object satisfies at least one condition.

According to various embodiments of the present disclosure, the executing the first action may include executing an application program related to the first contents or the second contents.

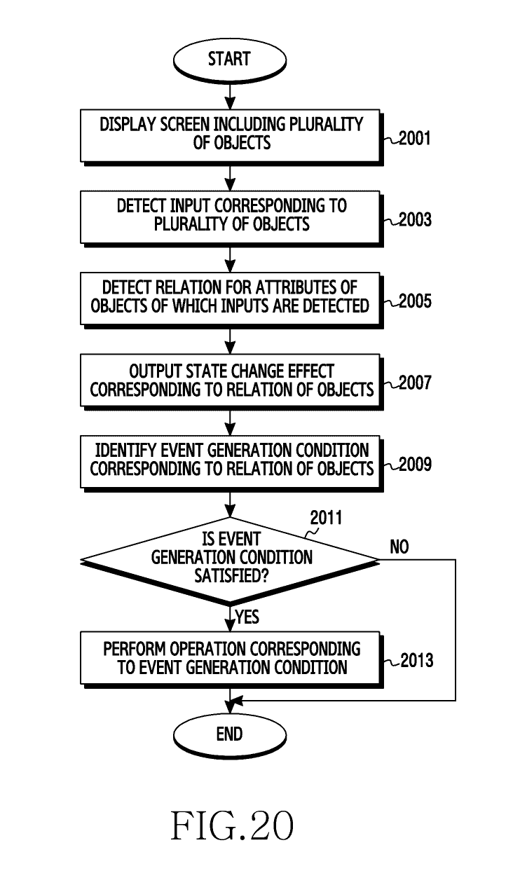

FIG. 20 illustrates a flowchart for outputting a state change effect based on a relation of a plurality of objects in an electronic device according to various embodiments of the present disclosure.

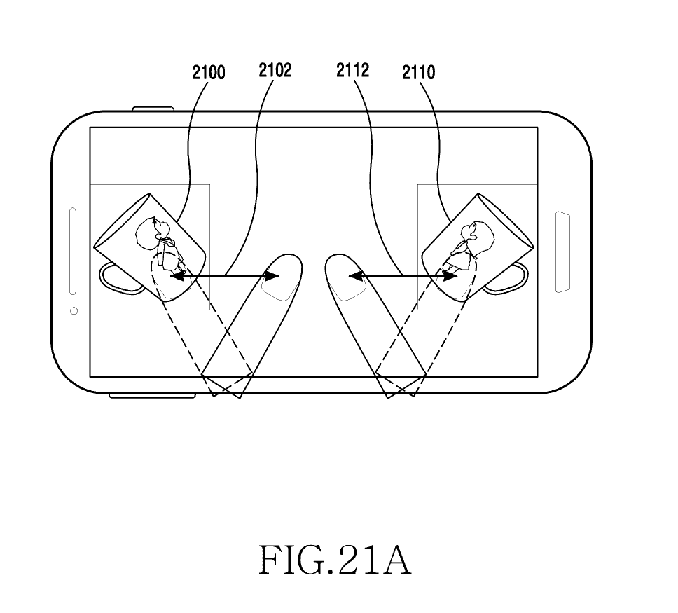

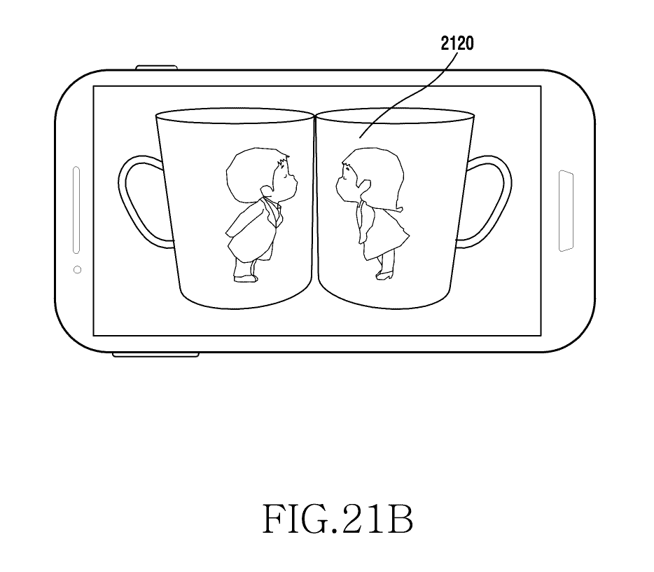

FIGS. 21A and 21B illustrate a screen configuration for outputting a state change effect based on a relation of a plurality of objects in an electronic device according to various embodiments of the present disclosure.

Referring to FIGS. 20, 21A and 21B, in operation 2001, an electronic device (e.g., the electronic device 101, 201 or 400) may display a screen including a plurality of objects on a display (e.g., the display 440). For example, the processor 410 may control the display 440 to display a background image including a first object 2100 including a picture of a man and a second object 2110 including a picture of a woman as shown in FIG. 21A.

In operation 2003, the electronic device may detect an input corresponding to the objects displayed on the display. For example, the processor 410 may detect a first drag input 2102 for a first object 2100 and a second drag input 2112 for a second object 2110 as shown in FIG. 21A.

In operation 2005, the electronic device may detect the relation for the attributes of the objects of which inputs are detected in response to the input detection corresponding to the objects. For example, the processor 410 may detect a relation for a man attribute of the first object 2100 and a woman attribute of the second object 2110 shown in FIG. 21A. For example, when the processor 410 satisfies a relation effect output condition (e.g., a mutual cross, a mutual approach, or the like) of the objects of which the inputs are detected, the processor 410 may detect the relation for attributes of the objects of the inputs are detected.

In operation 2007, the electronic device may output the state change effect such that the objects correspond to the relation for the attribute in response to the input detection corresponding to the objects. For example, the processor 410 may control the display 440 to output a state change effect in which the man picture of the first object 2100 and the woman image of the second object 2110 kiss such that the state change effect corresponds to the relation of the man attribute of the first object 2100 and the woman attribute of the second object 2110 as shown in FIG. 21B. For example, when the processor 410 satisfies the related state change effect output condition (e.g., a mutual cross, a mutual approach, or the like) of the objects of which the inputs are detected, the processor 410 may output the state change effect corresponding to the input information based on the relation of the attributes of the objects. When the processor 410 cannot satisfy the relation effect output condition of the objects of which the inputs are detected, the processor 410 may output different state change effects according to each object such that the state change effects correspond to input information and the attribute of each object.

In operation 2009, the electronic device may identify the event generation condition corresponding to the relation of the objects. For example, the processor 410 may detect the event generation condition corresponding to the relation for the man attribute of the first object 2100 and the woman attribute of the second object 2110 from the memory 430.

In operation 2011, the electronic device may check whether the input information corresponding to the objects satisfies the event generation condition of a corresponding object. For example, the processor 410 may check whether a drag distance of a first drag input 2102 and a second drag input 2112 is longer than a reference drag distance configured as the event generation condition in FIG. 21A.

In operation 2013, when the input information corresponding to the objects satisfies the event generation condition of a corresponding object, the electronic device may perform an operation corresponding to the event generation condition. For example, when the first drag input 2102 for the first object 2100 and the second drag input 2112 for the second object 2110 of FIG. 21A satisfy the event generation condition, the processor 410 may release a lock of the electronic device. For example, when the first drag input 2102 for the first object 2100 and the second drag input 2112 for the second object 2110 of FIG. 21A satisfy the event generation condition, the processor 410 may execute an application program corresponding to the relation of the objects. Additionally, the processor 410 may output an additional state change effect corresponding to the event generation condition satisfaction.

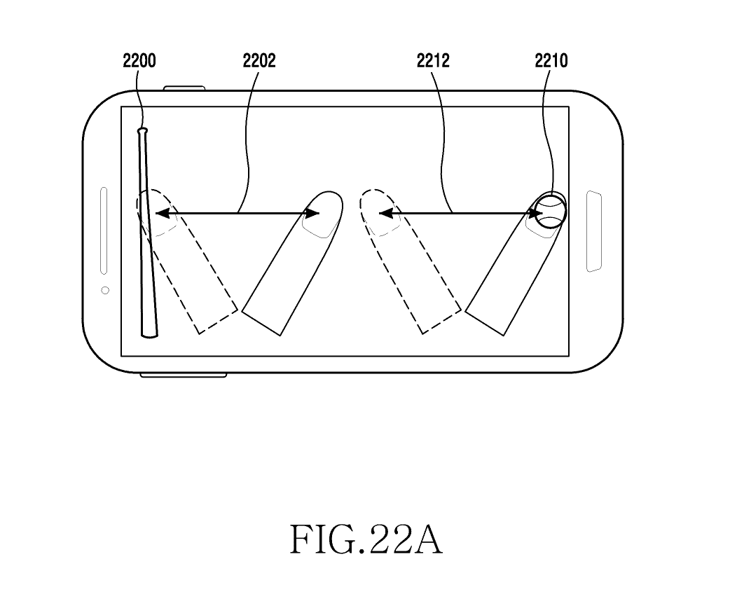

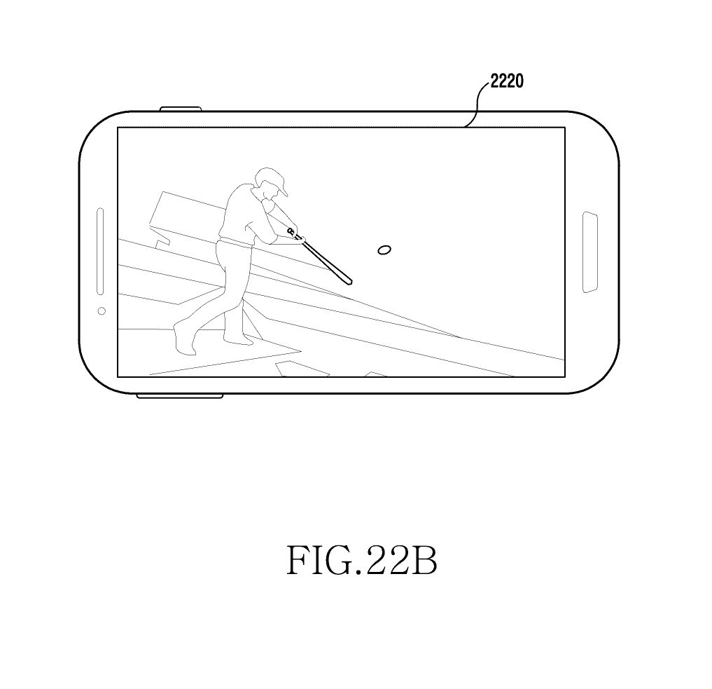

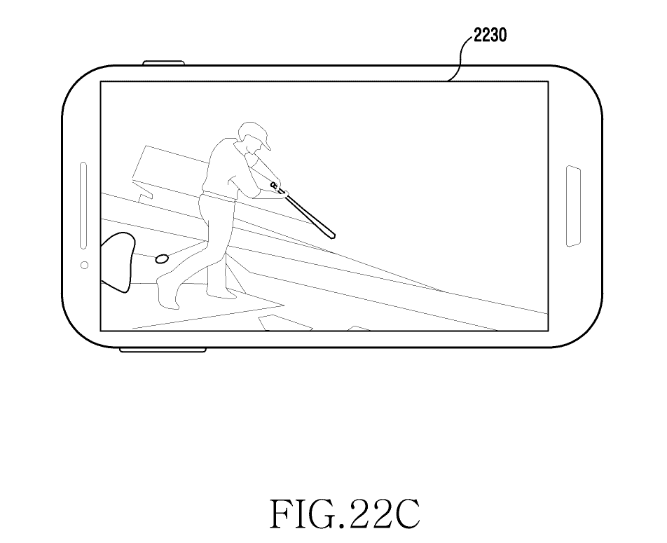

FIGS. 22A to 22C illustrate a screen configuration for outputting a state change effect corresponding to a relation of a plurality of objects in an electronic device according to various embodiments of the present disclosure. Hereinafter, an embodiment for outputting a state change effect corresponding to a relation of objects as shown in FIG. 20 is described.

Referring to FIGS. 22A to 22C, an electronic device (e.g., the electronic device 101, 201 or 400) may display a background image including a baseball bat object 2200 and a baseball object 2210 on a display (e.g., the display 440) as shown in FIG. 22A.

According to an embodiment of the present disclosure, when the electronic device detects a first drag input 2202 for the baseball bat object 2200, the electronic device may output a state change effect (e.g., a display position movement) for the baseball bat object 2200 such that the baseball bat object 2200 corresponds to the first drag input 2202. When the electronic device detects a second drag input 2212 for the baseball object 2210, the electronic device may output a state change effect (e.g., a display position movement) for the baseball object 2210 such that the baseball object 2210 corresponds to the second drag input 2212.

According to an embodiment of the present disclosure, the electronic device may check whether a relation effect output condition (e.g., a mutual cross, a mutual proximity, or the like) is satisfied based on the first drag input 2202 and the second drag input 2212. For example, the electronic device may check whether the baseball bat object 2200 and the baseball object 2210 mutually cross based on the first drag input 2202 and the second drag input 2212. When the baseball bat object 2200 and the baseball object 2210 mutually cross or come close to each other in a distance that is longer than a reference distance, the electronic device may determine that the relation effect output condition is satisfied.

According to an embodiment of the present disclosure, when the electronic device satisfies the relation effect output condition, the electronic device may detect the event generation condition corresponding to the relation for the baseball bat object 2200 and the baseball object 2210. For example, when the electronic device satisfies the relation effect output condition, the electronic device may output a state change effect in which the baseball bat object 2200 hits the baseball object 2210.

According to an embodiment of the present disclosure, when the first drag input 2202 for the baseball bat object 2200 and the second drag input 2212 for the baseball object 2210 of FIG. 22A satisfy the event generation condition, the electronic device may release a lock of the electronic device. For example, when the baseball object 2210 is matched to the center of the baseball bat object 2200, the processor 410 may determine that the event generation condition is satisfied and may release the lock of the electronic device. In this case, the electronic device may display, on the display as shown in FIG. 22B, a state change effect 2220 in which a home run is hit.

According to an embodiment of the present disclosure, when the first drag input 2202 for the baseball bat object 2200 and the second drag input 2212 for the baseball object 2210 of FIG. 22A do not satisfy the event generation condition, the electronic device may maintain the lock state of the electronic device. For example, when the baseball object 2210 is not matched to the center of the baseball bat object 2200, the processor 410 may determine that the event generation condition is not satisfied and may maintain the lock state of the electronic device. In this case, the electronic device may display, on the display as shown in FIG. 22C, a state change effect 2230 in which swing and miss is generated.

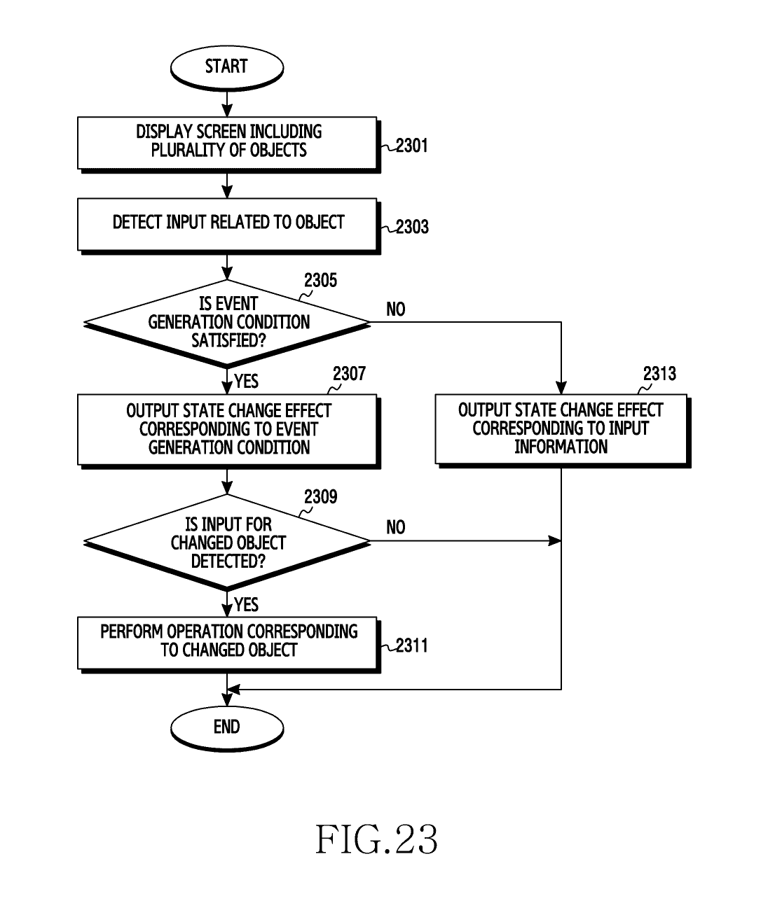

FIG. 23 illustrates a flowchart for performing an operation corresponding to an object in an electronic device according to various embodiments of the present disclosure.

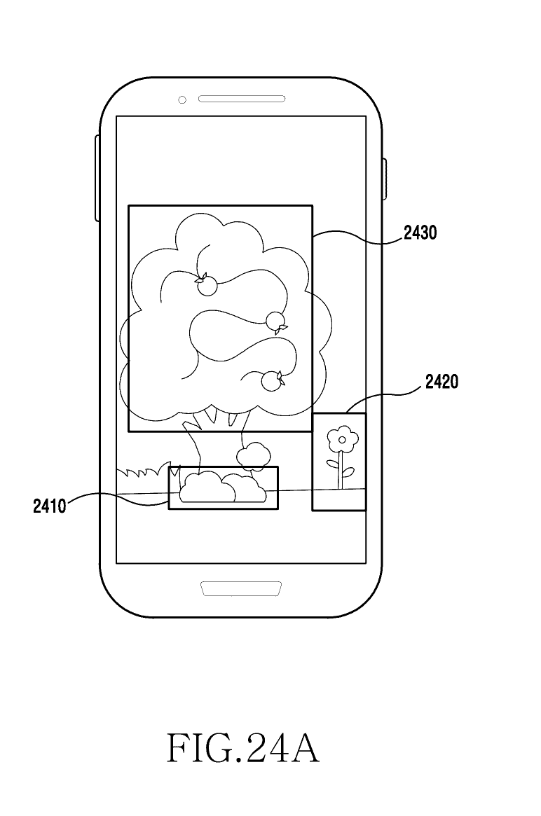

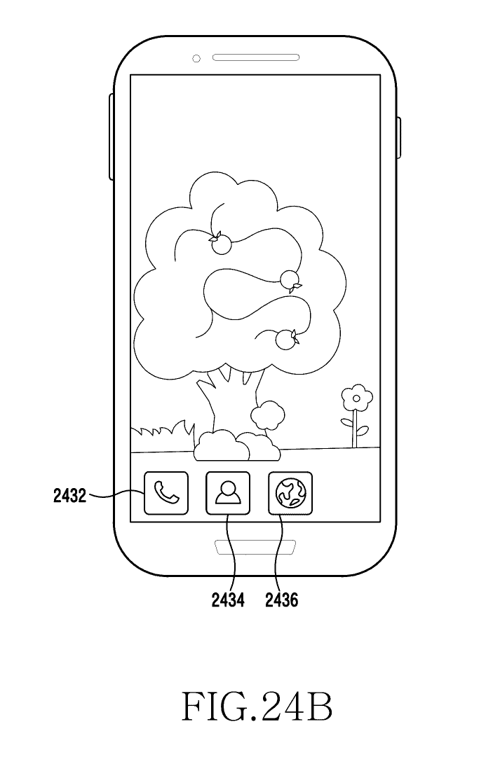

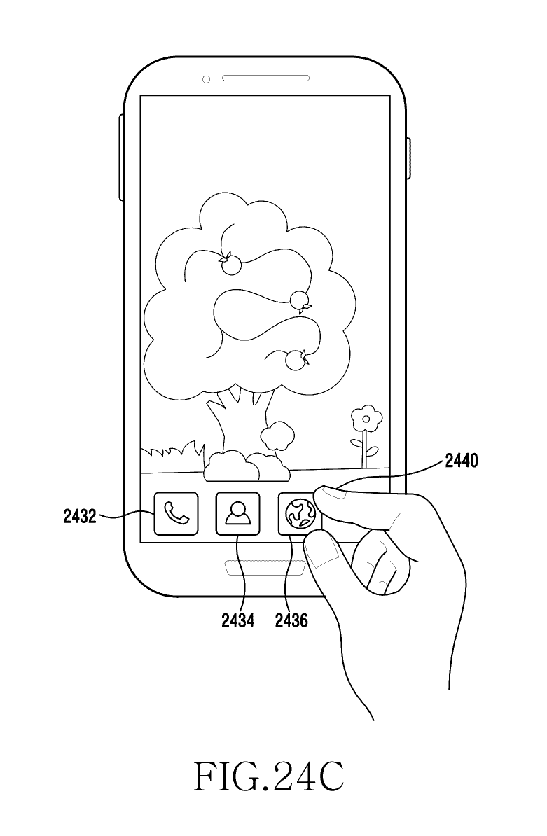

FIGS. 24A and 24B illustrate a screen configuration for performing an operation corresponding to an object in an electronic device according to various embodiments of the present disclosure.

Referring to FIGS. 23, 24A and 24B, in operation 2301, an electronic device (e.g., the electronic device 101, 201 or 400) may display a screen including a plurality of objects on a display (e.g., the display 440). For example, the processor 410 may control the display 440 to output a background image including a grass object 2410, a flower object 2420 and an apple tree object 2430 as shown in FIG. 24A.

In operation 2303, the electronic device may detect an input related to at least one object among the objects displayed on the display. For example, the processor 410 may detect a drag input for the apple tree object 2430 through the input interface 450 (e.g., the touch screen).

In operation 2305, the electronic device may check whether the input information related to the object satisfy an event generation condition of a corresponding object. For example, the processor 410 may check whether a distance of the drag input for the apple tree object 2430 satisfies the event generation condition of the apple tree object 2430.

In operation 2313, when the input information related to the object does not satisfy the event generation condition of the corresponding object, the electronic device may output a state change effect such that the state change effect corresponds to the input information related to the object. For example, when the processor 410 does not satisfy the event generation condition, the processor 410 may control the display 440 to output a state change effect in which the apple tree object 2430 shakes from side to side in accordance with the drag input.

In operation 2307, when the input information related to the object satisfies the event generation condition of the corresponding object, the electronic device may change the object displayed on the screen such that the object corresponds to the event generation condition. For example, when the drag input (e.g., drag distance) for the apple tree object 2430 is higher than a reference value, the processor 410 may control the display 440 to output a state change effect in which an apple is fallen from the apple tree object 2430. The processor 410 may control the display 440 to display application icons 2432, 2434, and 2436, which may be executed in the electronic device on each apple object as shown in FIG. 24B. For example, the processor 410 may display an icon of an application program designated by a user on each apple object. For example, the processor 410 may display an icon of an application program that has recently been used by a user on each apple object. For example, the processor 410 may display an icon of an application program which is frequently used by a user on each apple object.

In operation 2309, the electronic device may check whether an input for a changed object is detected. For example, the processor 410 may check whether an input for a display coordinate of an object on which each application icon is displayed is detected.

In operation 2311, when the electronic device detects 2440 the input for the changed object, the electronic device may perform an operation corresponding to the object of which the input is detected. For example, when the processor 410 detects an input 2440 corresponding to an action wherein an object 2436 on which an Internet icon is displayed is picked up as shown in FIG. 24C, the processor 410 may execute an Internet application program. Here, the input corresponding to the action in which the object is picked up may include a pinch-out input for the object.

According to various embodiments of the present disclosure, when the electronic device outputs a state change effect in which the apple object is fallen based on the drag input of the apple tree object 2430 shown in FIG. 24A, the electronic device may output the apple objects such that the number of the fallen apple objects is different so that the fallen apple object corresponds to the drag input (e.g., drag distance, speed or the like). In addition, the electronic device may output each apple object such that fallen speeds of each apple object are different based on characteristics of an application to be displayed on the fallen apple object. Here, the characteristics of the application may include at least one of a use number, a use period, a use time point, a priority, and an importance.

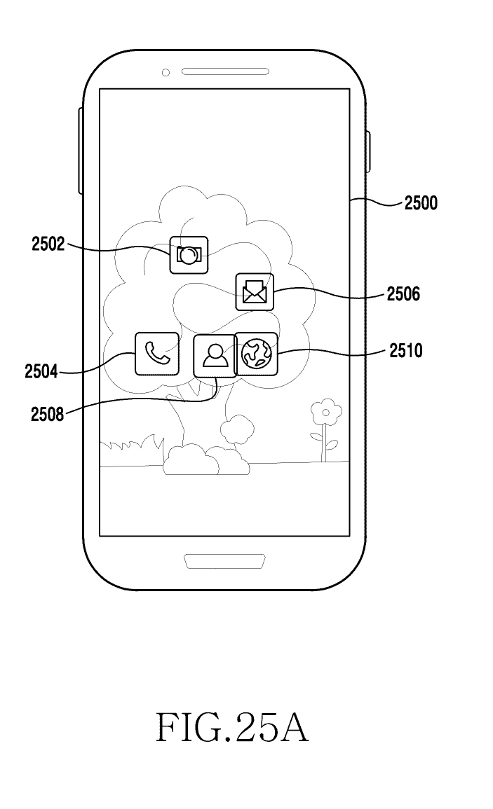

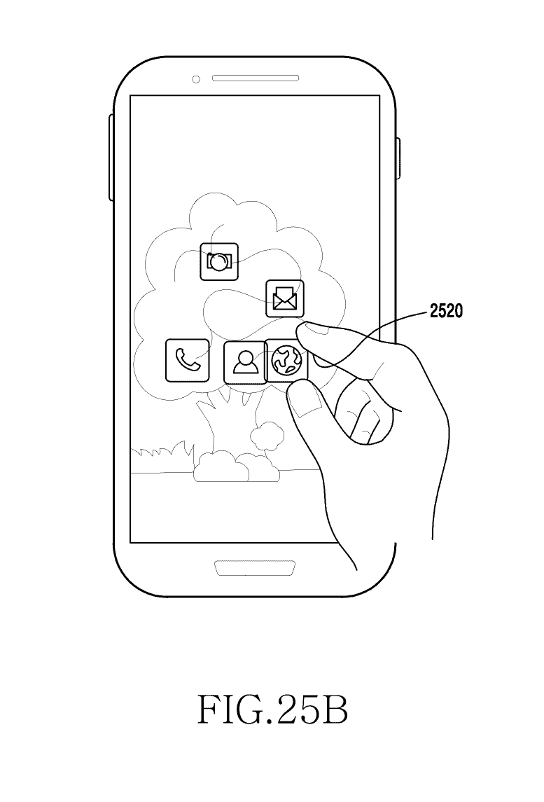

FIGS. 25A and 25B illustrate a screen configuration for performing an operation corresponding to an object based on a selection of the object in an electronic device according to various embodiments of the present disclosure. Hereinafter, an embodiment for performing an operation corresponding to the object as shown in FIG. 23 is described.

Referring to FIGS. 25A and 25B, when a drag input 740 satisfies an event generation condition for the apple tree object 730 as shown in FIG. 7B, the electronic device may display, on the display 440, application icons 2502, 2504, 2506, 2508, and 2510, which may be executed in the electronic device on each apple object displayed in the apple tree object 730 as shown in FIG. 25A. For example, the electronic device may change each apple object displayed in the apple tree object 730 to the application icons 2502, 2504, 2506, 2508, and 2510, which may be executed in the electronic device. In addition, the electronic device may display the objects on which the application icons are displayed or the application icons of which the objects are changed such that the sizes of the objects on which the application icons are displayed or the application icons of which the objects are changed are different, based on characteristics of the applications displayed on each apple object. For example, the application icon displayed on the object may include an icon of an application program designated by a user, a recently used application program, or a frequently used application program.

According to an embodiment of the present disclosure, when the electronic device detects 2520 an input (e.g., pinch-out) corresponding to an action wherein an object 2510, on which an Internet icon is displayed, is picked up as shown in FIG. 25B, the electronic device may execute an Internet application program.

According to various embodiments of the present disclosure, an electronic device may include a touch screen display, a processor electrically connected to the display, and a memory electrically connected to the processor. The memory may store instructions enabling the processor to provide a state in which the processor receives a touch input through only a selected area of the screen, while displaying a screen including a first object and a second object, using a substantial whole of the display, to display a third object which may trigger a first function and remove the first object, in response to at least some of a first user input selecting the first object, and to display a fourth object which may trigger a second function and remove the second object, in response to at least some of a second user input selecting the second object, when the instructions are executed.

According to various embodiments of the present disclosure, the screen may include a lock screen.

According to various embodiments of the present disclosure, the instructions may enable the processor to execute the first function in response to a third user input selecting the third object and to execute the second function in response to a fourth user input selecting the fourth object.

According to various embodiments of the present disclosure, an operation of an electronic device may include displaying a screen including a first object and a second object, using a substantial whole of a display of the electronic device, displaying a third object which may trigger a first function and removing the first object, in response to at least some of a first user input selecting the first object, and displaying a fourth object which may trigger a second function and removing the second object, in response to at least some of a second user input selecting the second object.

According to various embodiments of the present disclosure, the screen may include a lock screen.

According to various embodiments of the present disclosure, the operation may further include executing the first function in response to a third user input selecting the third object, and executing the second function in response to a fourth user input selecting the fourth object.

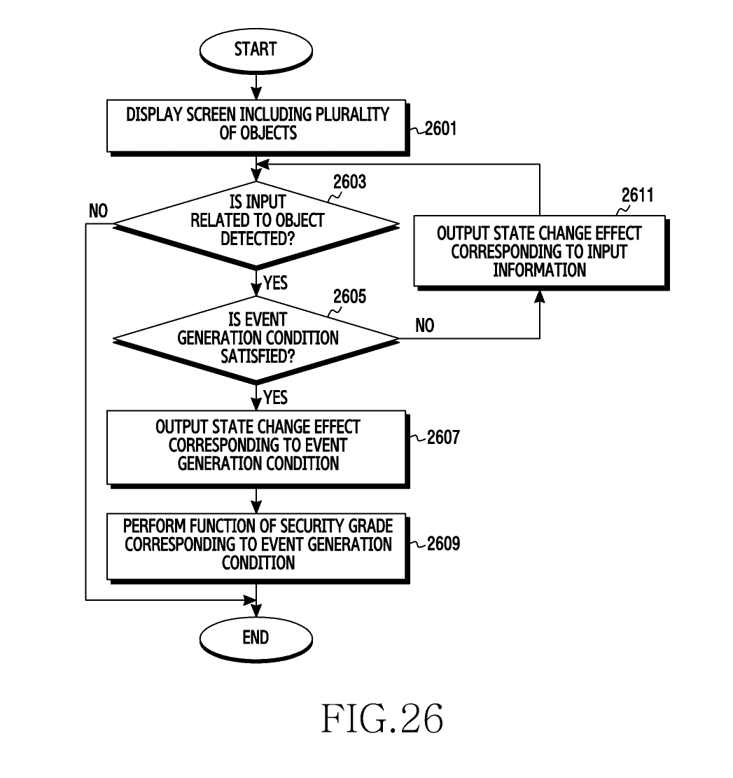

FIG. 26 illustrates a flowchart for configuring a security grade such that the security grade corresponds to an event generation condition in an electronic device according to various embodiments of the present disclosure.

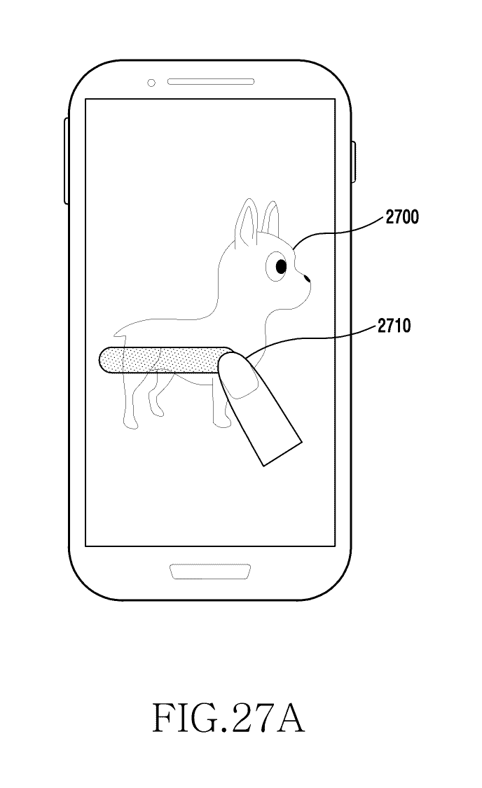

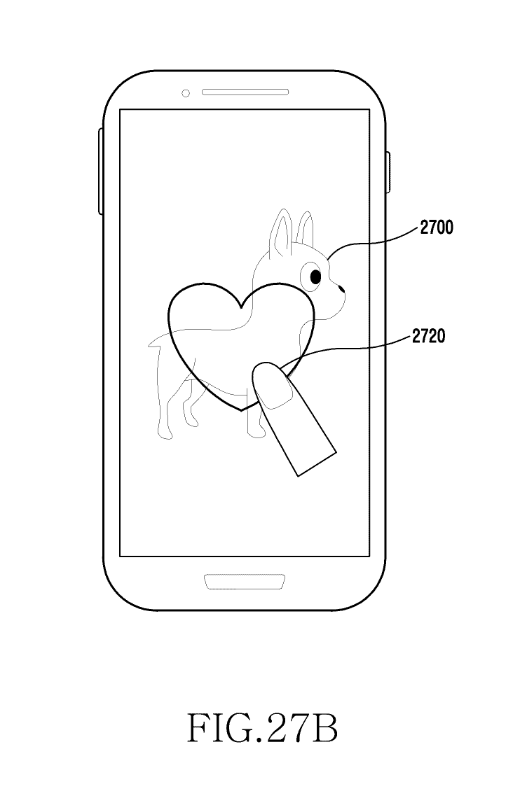

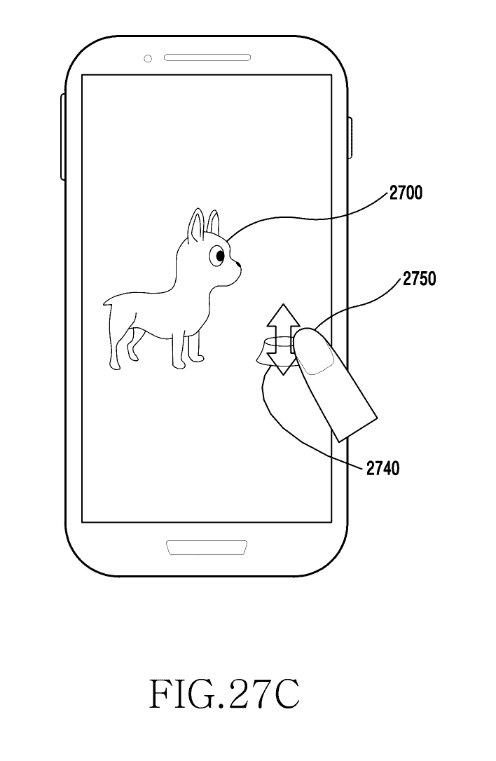

FIGS. 27A to 27C illustrate a screen configuration for configuring a security grade such that the security grade corresponds to an event generation condition in an electronic device according to various embodiments of the present disclosure.

Referring to FIGS. 26 and 27A to 27C, in operation 2601, an electronic device (e.g., the electronic device 101, 201 or 400) may display a screen including at least one object on a display (e.g., the display 440). For example, the processor 410 may control the display 440 to output a background image (e.g., a lock screen) including a dog object 2700 as shown in FIG. 27A.

In operation 2603, the electronic device may check whether an input related to at least one object displayed on the display is detected. For example, the processor 410 may check whether a drag input 2710 for the dog object 2700 as shown in FIG. 27A is detected through the input interface 450 (e.g., the touch screen). Alternatively, the processor 410 may check whether a pattern input 2720 (e.g., a heart pattern) for the dog object 2700 as shown in FIG. 27B is detected through the input interface 450 (e.g., the touch screen).

In operation 2605, when the electronic device detects the input related to the object, the electronic device may check whether input information satisfies an event generation condition of a corresponding object. For example, the processor 410 may check whether the input information related to the object satisfies an event generation condition among a plurality of event generation conditions corresponding to the dog object 2700. For example, the plurality of event generation conditions may be matched to different security grades.

In operation 2611, when the input information related to the object does not satisfy the event generation condition of the corresponding object, the electronic device may output the state change effect such that the state change effect corresponds to the input information related to the object. For example, the processor 410 may control the display 440 to output a state change effect in which the dog object moves in a drag direction in accordance with the drag input 2710 for the dog object 2700 as shown in FIG. 27A. For example, the processor 410 may control an audio module to output the sound of a dog's barking, in accordance with the drag input 2710 for the dog object 2700 as shown in FIG. 27A.

In operation 2603, the electronic device may check again whether the input related to the one or more objects is detected.

In operation 2607, when the input information related to the object satisfies the event generation condition of the corresponding object, the electronic device may output a state change effect corresponding to the event generation condition. For example, when the drag input (e.g., drag distance) for the dog object 2700 as shown in FIG. 27A is higher than a reference value, the processor 410 may control the display 440 to output a state change effect (e.g., lock release effect) for a security grade of the event generation condition corresponding to the drag input 2710.

In operation 2609, the electronic device may configure a function of the security grade corresponding to the event generation condition by the input information related to the object. For example, when the processor 410 satisfies an event generation condition of a first security grade by the drag input 2710 for the dog object 2700 as shown in FIG. 27A, the processor 410 may release a lock screen to perform only a specific function (e.g., a camera function) based on the first security grade. For example, when the processor 410 satisfies an event generation condition of a second security grade by the pattern input 2720 for the dog object 2700 as shown in FIG. 27B, the processor 410 may release a lock screen to limit the use or access of at least some function based on the second security grade. For example, when the processor 410 satisfies an event generation condition of a third security grade by a touch input 2750 for a rice bowl 2740 object as shown in FIG. 27C, the processor 410 may release the lock screen to allow the use or access of a whole function of the electronic device based on the third security grade. Here, the security grade may include a range of information, a function and an application program which may be used or accessed by a user in the electronic device.

According to various embodiments of the present disclosure, the electronic device may differently configure the event generation condition (e.g., lock release condition) in accordance with a predetermined security grade. For example, the first security grade may be configured as a grade which may release the lock (e.g., the lock screen) of the electronic device using all objects in the background image. The second security grade may be configured as a grade which may release the lock of the electronic device using a specific object among the various objects in the background image. The third security grade may be configured as a grade which may release the lock of the electronic device based on a specific condition for the specific object among the various objects in the background image.

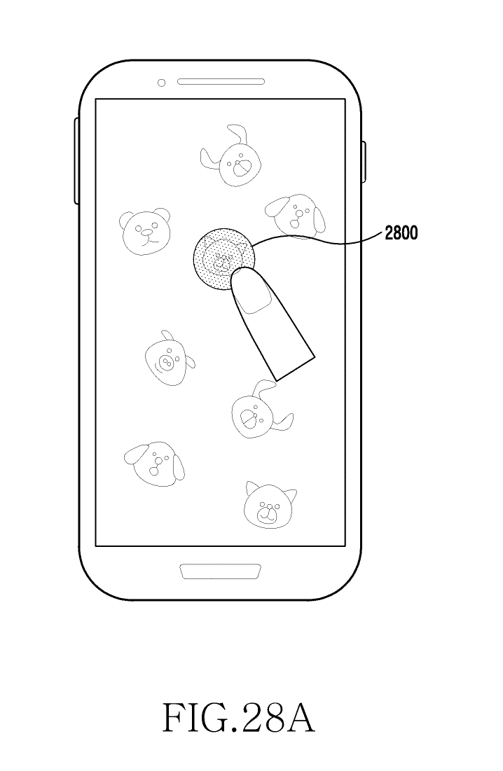

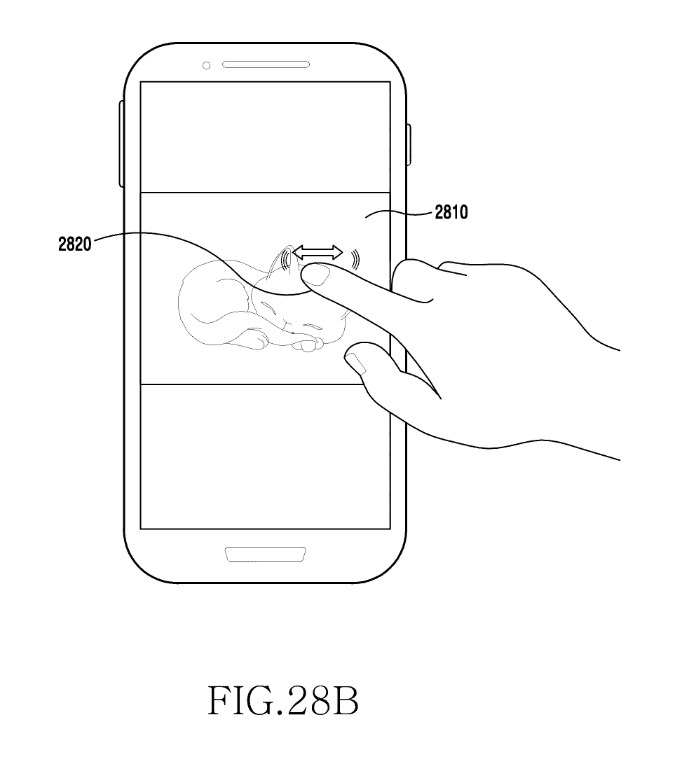

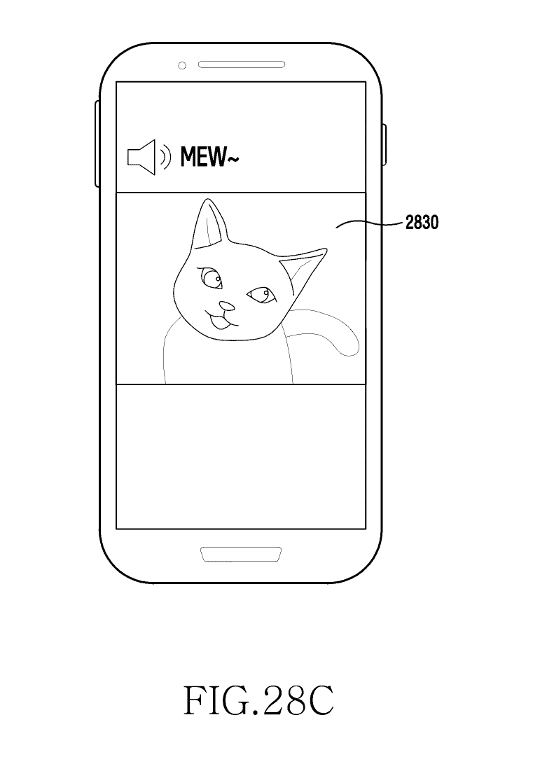

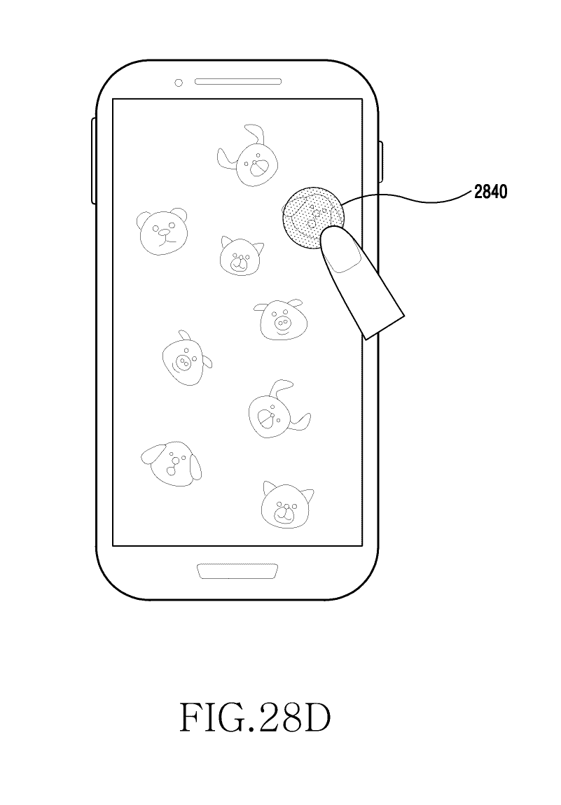

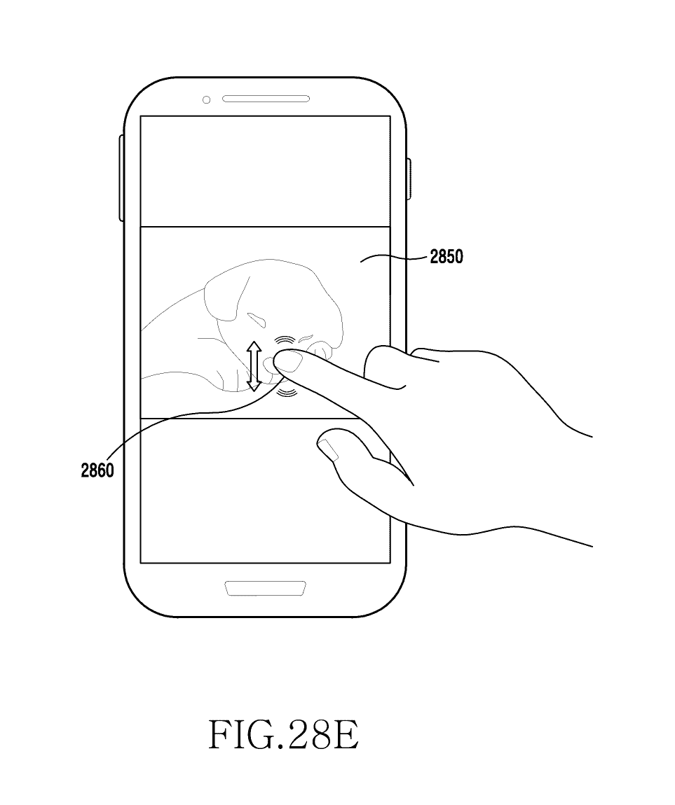

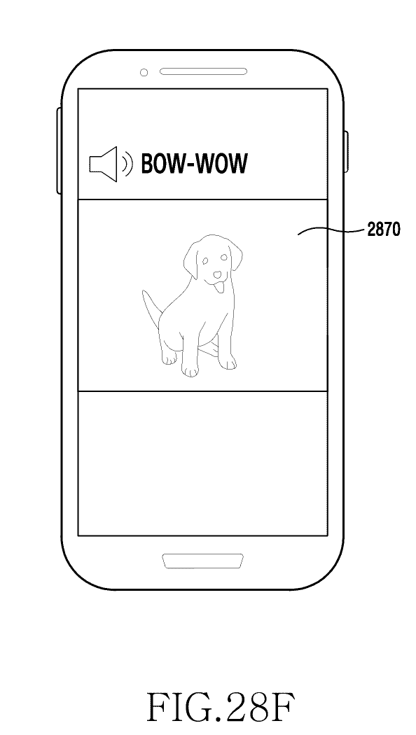

FIGS. 28A to 28F illustrate a screen configuration for highlighting a state change effect corresponding to an object attribute in an electronic device according to various embodiments of the present disclosure.

Referring to FIGS. 28A to 28F, an electronic device (e.g., the electronic device 101, 201 or 400) may highlight the state change effect for the object using an additional image. For example, the electronic device may display a background image including a plurality of animal face objects on a display (e.g., the display 440) as shown in FIG. 28A. When the electronic device detects a touch input 2800 for a cat face object, the electronic device may display a sleeping cat image 2810 on the display as shown in FIG. 28B. In addition, when the electronic device detects a drag input 2820 for the sleeping cat image 2810 of FIG. 28B, the electronic device may display a smiling cat image 2830 on the display as shown in FIG. 28C. At this time, the electronic device may output a cat's crying sound through a speaker.

For example, the electronic device may display a background image including a plurality of animal face objects on the display (e.g., the display 440) as shown in FIG. 28D. When the electronic device detects a touch input 2840 for a dog face object, the electronic device may display a sleeping dog image 2850 on the display as shown in FIG. 28E. In addition, when the electronic device detects a drag input 2860 for the sleeping dog image 2850 of FIG. 28E, the electronic device may display a dog image 2870 on the display as shown in FIG. 28F. At this time, the electronic device may output a dog's barking sound through a speaker.

According to various embodiments of the present disclosure, the electronic device may dynamically change a background image providing a state change effect. For example, when an image or a theme of a lock screen is configured as an entertainer, the processor 410 may dynamically change the lock screen such that the lock screen corresponds to schedule information of the entertainer of the time point when the lock screen is displayed.

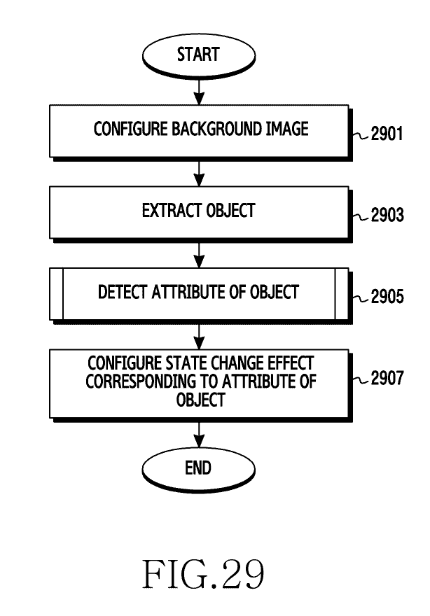

FIG. 29 illustrates a flowchart for configuring a state change effect corresponding to an object attribute in an electronic device according to various embodiments of the present disclosure.

Referring to FIG. 29, in operation 2901, an electronic device (e.g., the electronic device 101, 201 or 400) may configure a background image. For example, the processor 410 may configure the background image displayed as a lock screen.

In operation 2903, the electronic device may extract at least one object included in the background image. For example, the processor 410 may analyze an edge component of the background image to extract at least one object included in the background image.

In operation 2905, the electronic device may detect attributes of each object detected in the background image. For example, the processor 410 may detect the attributes of each object detected in the background image, from an object attribute table stored in the memory 430. For example, the processor 410 may receive the attributes of each object from a user by displaying an object attribute input menu on the display 440. For example, the processor 410 may receive attribute information of each object from an external device (e.g., server). For example, the processor 410 may map a predetermined attribute (e.g., a reference attribute stored in the memory 430) to the attributes of each object by displaying the predetermined attribute (e.g., a reference attribute stored in the memory 430) on the display 440. For example, the predetermined attribute may include a block, a water drop, a grass, an animal or the like.

In operation 2907, the electronic device may configure a state change effect corresponding to the attributes of each object.

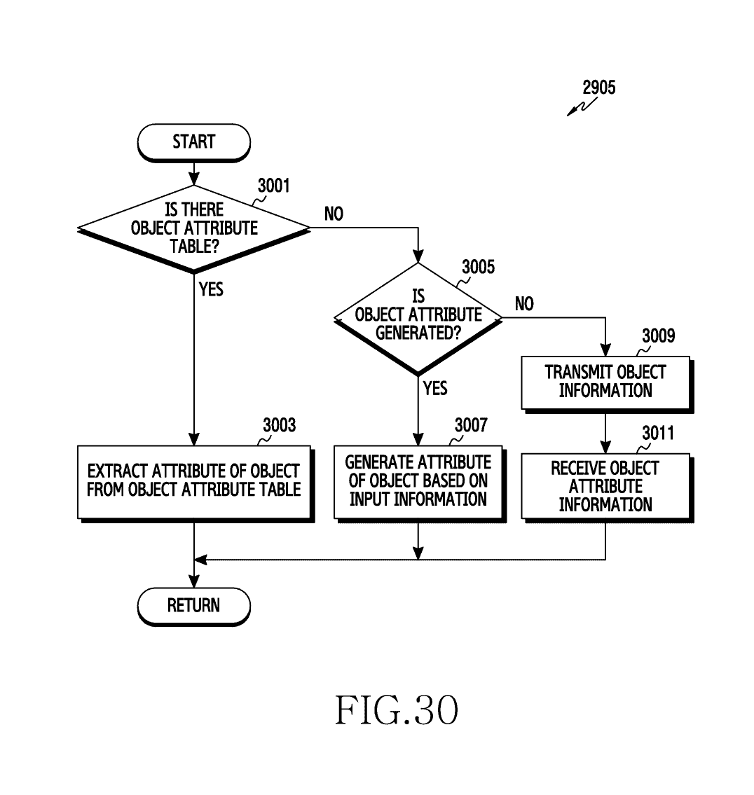

FIG. 30 illustrates a flowchart for generating a state change effect corresponding to an object attribute in an electronic device according to various embodiments of the present disclosure. Hereinafter, an operation for detecting the attribute of the object in operation 2905 of FIG. 29 is described.

Referring to FIG. 30, in operation 3001, an electronic device (e.g., the electronic device 101, 201 or 400) may check whether the object attribute table including the object attribute information is stored in the memory (e.g., the memory 430).

In operation 3003, when the object attribute table is stored in the memory, the electronic device may detect the attributes of each object included in the background image detected in operation 2903, from the object attribute table.

In operation 3005, the electronic device may check whether the electronic device may generate the object attribute, when the object attribute table is not stored in the memory. For example, the processor 410 may control the display 440 to display an object attribute input menu. The processor 410 may check whether the object attribute information is input during a reference time after a time point when the object attribute input menu is displayed. For example, the processor 410 may check whether a category table for generating the object attribute is included in the memory 430. For example, the processor 410 may check whether the processor 410 may generate an attribute of a corresponding object automatically through an image processing for the object detected in the background image.

In operation 3007, when the electronic device generates the object attribute, the electronic device may generate the attributes for each object included in the background image detected in operation 2903 based on the input information. Alternatively, the processor 410 may generate the attributes of each object included in the background image using a category table. In addition, the processor 410 may generate the attribute of the corresponding object automatically through an image processing for the object detected in the background image.

In operation 3009, when the electronic device cannot generate the object attribute, the electronic device may transmit the object information to an external device (e.g., server). For example, the processor 410 may transmit an attribute information request signal including the object information to the external device through the communication interface 460.

In operation 3011, the electronic device may receive the object attribute information from the external device. For example, the processor 410 may receive the object attribute information in response to the attribute information request signal through the communication interface 460.

According to various embodiments of the present disclosure, when the electronic device cannot detect or generate the attribute of the object, or cannot receive the object attribute information from the external device, the electronic device may configure (or define) the attributes of each object detected in the background image as a predetermined attribute. Here, the predetermined attribute may include a reference attribute stored in the memory (e.g., the memory 430) of the electronic device.

According to various embodiments of the present disclosure, the electronic device may determine the attribute of the object detected in the background image based on the attribute of the object provided from the external device and the attribute of the object generated in the electronic device. For example, the electronic device may generate the attribute of the object detected in the background image (operation 3003 or operation 3007). The electronic device may receive the attribute information of each object by transmitting configuration information of the background image and object information detected in the background image to the external device. The electronic device may determine the attribute of the object detected in the background image by comparing the attribute information generated in the electronic device with the attribute information received from the external device. For example, when the attribute information generated in the electronic device and the attribute information received from the external device are the same, the electronic device may determine that a corresponding attribute is the attribute of the object detected in the background image.

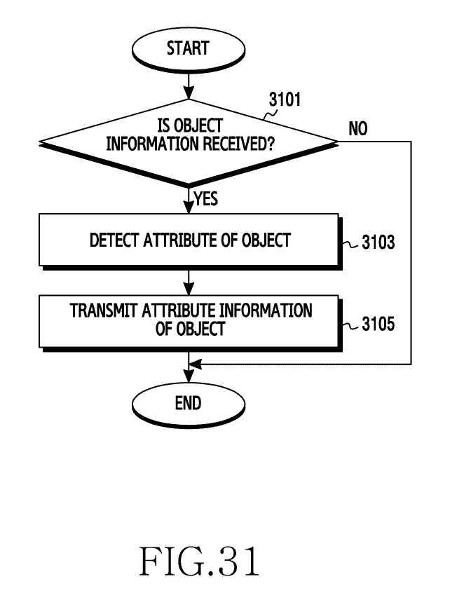

FIG. 31 illustrates a flowchart for configuring a state change effect corresponding to an object attribute in a server according to various embodiments of the present disclosure. Hereinafter, an operation of an external device corresponding to the electronic device operation (e.g., operation 3009 and operation 3011) of FIG. 30 is described.

Referring to FIG. 31, in operation 3101, the external device may check whether object information is received from the electronic device. For example, the external device may check whether the attribute information request signal including the object attribute information is received.

In operation 3103, the external device may detect attribute information on each object received from the electronic device. For example, the external device may extract, from the object attribute table that is pre-stored in the external device, the attribute information on each object received from the electronic device. For example, the external device may generate attribute information of a corresponding object through an image processing for each object received from the electronic device.

In operation 3105, the external device may transmit the attribute information on each object received from the electronic device to the electronic device.

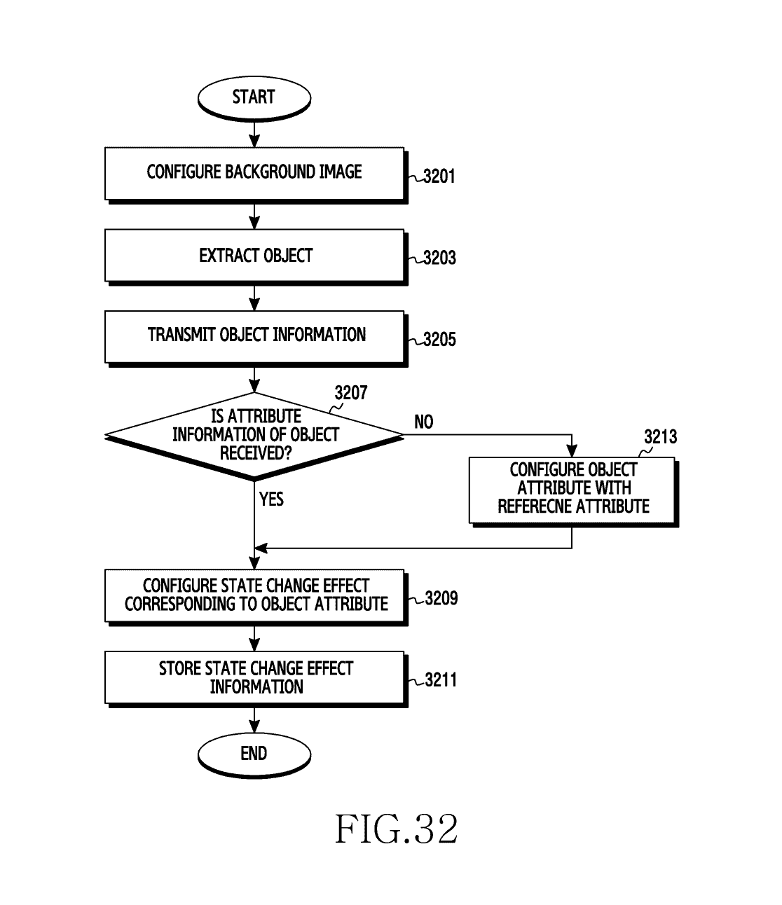

FIG. 32 illustrates a flowchart for configuring a state change effect corresponding to an object attribute using a server in an electronic device according to various embodiments of the present disclosure.

Referring to FIG. 32, in operation 3201, an electronic device (e.g., the electronic device 101, 201 or 400) may configure a background image (e.g., a lock screen).

In operation 3203, the electronic device may extract at least one object included in the background image. For example, the processor 410 may extract at least one object included in the background image by analyzing an edge component of the background image.

In operation 3205, the electronic device may transmit object information detected from the background image to an external device. For example, the processor 410 may transmit an attribute information request signal including the object information detected from the background image to the external device through the communication interface 460.

In operation 3207, the electronic device may check whether the object attribute information is received. For example, the processor 410 may check whether a response signal for the attribute information request signal is received through the communication interface 460.

In operation 3213, when the electronic device cannot receive the attribute information of the object during a reference time from a time point when the electronic device transmits the object information, the electronic device may configure an attribute for at least one object extracted from the background image with a predetermined reference attribute. For example, when the processor 410 cannot receive the attribute information of the object from the external device during the reference time from the time point when the processor 410 transmits the object information, the processor 410 may configure the attributes for each object extracted from the background image with the reference attribute stored in the memory 430.

In operation 3209, the electronic device may configure a state change effect corresponding to the attributes of each object, which are provided from the external device or configured as the reference attribute.

In operation 3211, the electronic device may store, in the memory (e.g., the memory 430), configuration information of the state change effect corresponding to the attribute of the object.

According to various embodiments of the present disclosure, the external device corresponding to the operation (e.g., operation 3205 and operation 3207) of the electronic device may be operated equally to that of the FIG. 31.

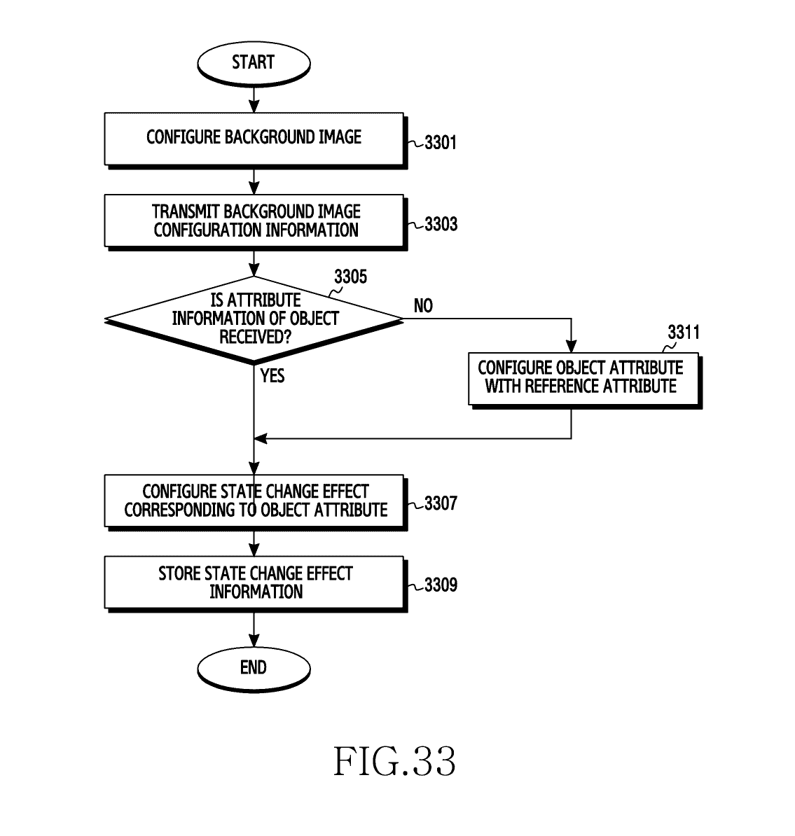

FIG. 33 illustrates a flowchart for configuring a state change effect corresponding to an object attribute using a server in an electronic device according to various embodiments of the present disclosure.

Referring to FIG. 33, in operation 3301, an electronic device (e.g., the electronic device 101, 201 or 400) may configure a background image (e.g., a lock screen).

In operation 3303, the electronic device may transmit background image configuration information to an external device. For example, the processor 410 may transmit an attribute information request signal including the background image configuration image to the external device through the communication interface 460.

In operation 3305, the electronic device may check whether object attribute information is received. For example, the processor 410 may check whether a response signal for the attribute information request signal is received through the communication interface 460.

In operation 3311, when the electronic device does not receive the attribute information of the object from the external device for a reference time after transmitting the object information, the electronic device may configure an attribute for at least one object extracted from the background image with a reference attribute stored in a memory (e.g., the memory 430).

In operation 3307, the electronic device may configure a state change effect corresponding to attributes of each object provided from the external device or configured with the reference attribute.

In operation 3309, the electronic device may store, in the memory (e.g., the memory 430), configuration information of the state change effect corresponding to the attribute of the object.

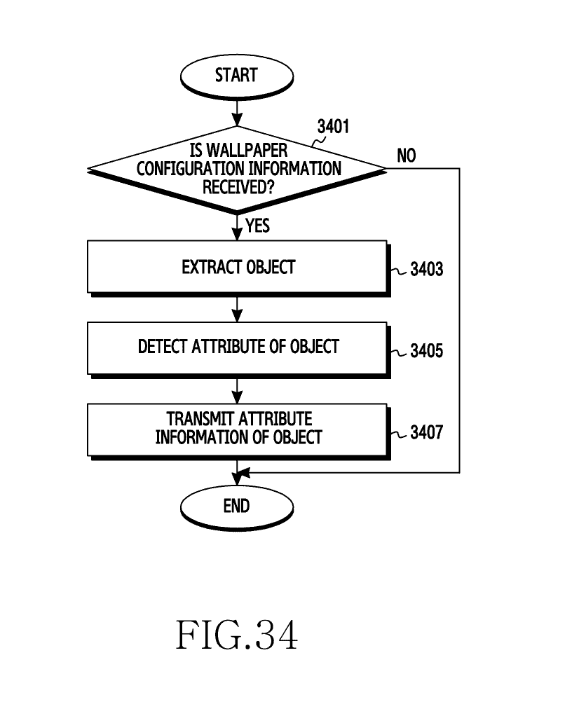

FIG. 34 illustrates a flowchart for detecting an attribute of an object included in the wallpaper provided from an electronic device by a server according to various embodiments of the present disclosure. Hereinafter, an operation of the external device corresponding to the operation (e.g., operation 3303 and operation 3305) of the electronic device of FIG. 33.

Referring to FIG. 34, in operation 3401, the external device may check whether the background image configuration information is received from the electronic device. For example, the external device may check whether the attribute information request signal, including the background image configuration information, is received.

In operation 3403, the external device may extract at least one object included in the background image configured in the electronic device. For example, the external device may extract at least one object included in the background image by analyzing an edge component of the background image.

In operation 3405, the external device may extract attribute information on each object extracted from the background image, from a previously configured object attribute table.

In operation 3407, the external device may transmit, to the electronic device, the attribute information on each object extracted from the object attribute table.

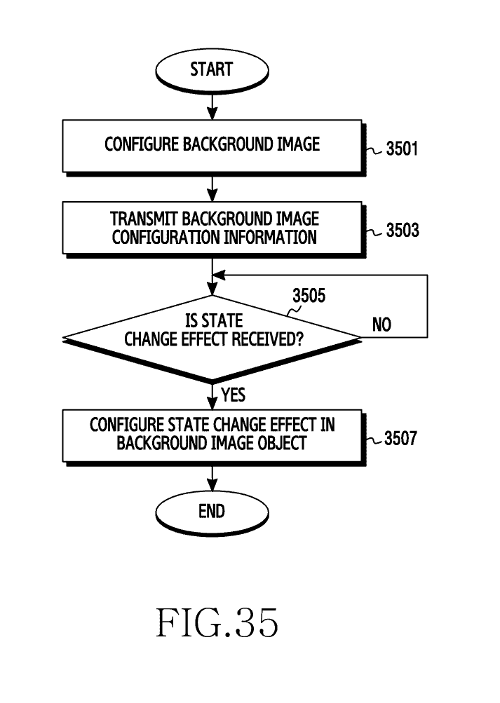

FIG. 35 illustrates a flowchart for configuring a state change effect of an object included in the wallpaper using a server in an electronic device according to various embodiments of the present disclosure.

Referring to FIG. 35, in operation 3501, an electronic device (e.g., the electronic device 101, 201 or 400) may configure a background image (e.g., a lock screen).

In operation 3503, the electronic device may transmit background image configuration information to an external device. For example, the processor 410 may transmit a state change effect request signal including the background image or a thumbnail of the background image to the external device through the communication interface 460.

In operation 3505, the electronic device may check whether state change effect information is received. For example, the processor 410 may check whether a response signal for the state change effect request signal is received through the communication interface 460.

In operation 3507, when the electronic device receives the state change effect information, the electronic device may store, in a memory (e.g., the memory 430), the state change effect information corresponding to attributes of each object.

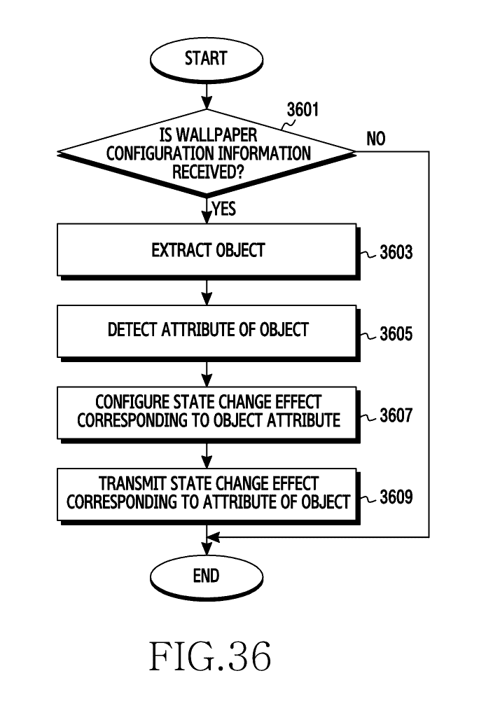

FIG. 36 illustrates a flowchart for configuring a state change effect of an object included in wallpaper provided from an electronic device, by a server according to various embodiments of the present disclosure. Hereinafter, an operation of the external device corresponding to the operation (e.g., operation 3503 and operation 3505) of the electronic device of FIG. 35 is described.

Referring to FIG. 36, in operation 3601, the external device may check whether the background image configuration information is received from the electronic device. For example, the external device may check whether the attribute information request signal including the background image configuration information is received.

In operation 3603, the external device may extract at least one object included in the background image configured in the electronic device. For example, the external device may extract at least one object included in the background image by analyzing an edge component of the background image.

In operation 3605, the external device may extract attribute information on each object extracted from the background image, from a previously configured object attribute table.

In operation 3607, the external device may configure the state change effect corresponding to the object attribute of the background image configured in the electronic device.

In operation 3609, the external device may transmit the state change effect information corresponding to object attribute to the electronic device.

According to various embodiments of the present disclosure, when the electronic device cannot detect or generate the attribute of the object or the state change effect in the electronic device, the electronic device may configure the attributes of each object detected from the background image with a previous configured attribute. For example, when the processor 410 cannot detect the attribute of the object from the object attribute table and cannot generate the object attribute, the processor 410 may define the attribute of the object detected from the background image with the previous configured attribute (e.g., reference attribute). For example, when the processor 410 cannot configure the state change effect of the object detected from the background image, the processor may configure a basic state change effect (e.g., shaking) stored in the memory 430 as the state change effect of the object detected from the background image.

An electronic device and a method of operating thereof according to various embodiments may provide various types of user interfaces, by providing a state change effect of a corresponding object based on input information on at least one object and an attribute of an object.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which has been known or are to be developed hereinafter.

According to various embodiments of the present disclosure, at least some of the devices (for example, modules or functions thereof) or the method (for example, operations) according to the present disclosure may be implemented by a command stored in a computer-readable storage medium in a program module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (for example, a magnetic tape), optical media (for example, a compact disc read only memory (CD-ROM) and a digital versatile disk (DVD)), magneto-optical media (for example, a floptical disk), a hardware device (for example, a read only memory (ROM), a random access memory (RAM), a flash memory), and the like. In addition, the program instructions may include high class language codes, which can be executed in a computer by using an interpreter, as well as machine codes made by a compiler. Any of the hardware devices as described above may be configured to work as one or more software modules in order to perform the operations according to various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a touch screen display;
a processor electrically connected to the touch screen display; and
a memory electrically connected to the processor,
wherein the memory is configured to store instructions that when executed configure the processor to:
control the touch screen display to display a background image including a first object and a second object as a lock screen on the touch screen display,
extract the first object and the second object in the background image,
receive a touch or a gesture input related to the first object or the second object through the touch screen display,
control the touch screen display to display a first visual effect on the screen when the processor receives an input related to the first object, and
control the touch screen display to display a second visual effect on the screen when the processor receives an input related to the second object.

2. The electronic device of claim 1, wherein the instructions, when executed, configure the processor to:
obtain first information related to a first attribute of the first object and second information related to a second attribute of the second object from the memory, and
determine at least one condition based on at least some of relations of the first attribute and the second attribute.

3. The electronic device of claim 2, wherein the instructions include instructions that when executed configure the processor to:
execute a first action when a first movement of the first object by the input related to the first object or a second movement of the second object by the input related to the second object satisfies at least one condition, and
execute a second action when the first movement or the second movement does not satisfy at least one condition.

4. The electronic device of claim 3, wherein the first action is a lock release of the screen or an execution of an application program corresponding to information of each object.

5. The electronic device of claim 1, wherein the instructions include instructions that when executed configure the processor to display a third visual effect on the screen when the processor receives the input related to the first object and the input related to the second object.

6. The electronic device of claim 5, wherein the third visual effect is determined based on a relation of the attribute of the first object and the attribute of the second object.

7. The electronic device of claim 1, wherein the first visual effect is determined based on at least one of the attribute of the first object, an attribute of the lock screen, or system information.

8. An electronic device comprising:
a touch screen display;
a processor electrically connected to the touch screen display; and
a memory electrically connected to the processor,
wherein the memory is configured to store instructions that when executed configure the processor to:
provide a state in which the processor receives a touch input through only a selected area of the screen, while displaying a screen including a first object of a first size, on a substantial whole of the touch screen display,
control the touch screen display to display a first amount of first contents in the first object on the touch screen display,
change the first object to a second size different from the first size on the touch screen display, and
control the touch screen display to display a second amount of the first contents or second contents related to the first contents in the first object of the second size on the touch screen display, when the instructions are executed.

9. The electronic device of claim 8, wherein the instructions include instructions that when executed configure the processor to change the first object to the second size different from the first size when the processor detects an input for the first object.

10. The electronic device of claim 8, wherein the screen includes a lock screen.

11. The electronic device of claim 8, wherein the instructions include instructions that when executed configure the processor to execute a first action when a first movement of the first object by the input related to the first object satisfies at least one condition.

12. The electronic device of claim 10, wherein the first action is an execution of an application program related to the first contents or the second contents.

13. An electronic device comprising:
a touch screen display;
a processor electrically connected to the touch screen display; and
a memory electrically connected to the processor,
wherein the memory is configured to store instructions that when executed configure the processor to:
provide a state in which the processor receives a touch input through only a selected area of the screen, while displaying a screen including a first object and a second object, using a substantial whole of the touch screen display,
control the touch screen display to display a third object which may trigger a first function and remove the first object, in response to at least some of a first user input selecting the first object, and
control the touch screen display to display a fourth object which may trigger a second function and remove the second object, in response to at least some of a second user input selecting the second object, when the instructions are executed.

14. The electronic device of claim 13, wherein the screen includes a lock screen.

15. The electronic device of claim 13, wherein the instructions, when executed, configure the processor to:
execute the first function in response to a third user input selecting the third object, and
execute the second function in response to a fourth user input selecting the fourth object.
